(19) United States
(12) Patent Application Publication
(10) Pub. No.: US 2018/0260442 A1
(43) Pub. Date: Sep. 13, 2018

(54) SELF-TUTORING GRAPH OF EVENT DATA

(71) Applicant: Microsoft Technology Licensing, LLC, Redmond, WA (US)

(72) Inventors: Vishnuvardhan Vaidhyanathan, Bellevue, WA (US); John Taylor, Bellevue, WA (US); Robert Standefer, Duvall, WA (US)

(73) Assignee: Microsoft Technology Licensing, LLC, Redmond, WA (US)

(21) Appl. No.: 15/455,324

(22) Filed: Mar. 10, 2017

(51) Int. Cl. G06F 17/30

(52) U.S. Cl. CPC G06F 17/30477; G06F 17/30958; G06F 17/30598

(57) ABSTRACT

Systems and methods of generating and querying event data are provided. The event data may be processed so as to generate collections of event data in a graphical representation, the graphical representation having identifiers and relationships between those identifiers. Event data may be tracked for various resources (e.g., websites, webpages, web elements, files, applications, etc.) and may be associated with identifiers, e.g., resource type, event type, value type, etc. Rulesets may be applied to collections of event data to generate inferred data, e.g., inferred relationships, and to create enriched collections. Base on the collections and/or enriched collections, a library specifying the resources and/or events for tracking may be annotated. Moreover, based on the collections and/or enriched collections, the rulesets may be modified to generate additional or different inferred data. In some aspects, automatic annotations to the library and/or modifications to the rulesets may generate a self-tutoring graph of event data.

### BACKGROUND

Event tracking generally refers to recording user and/or machine interactions with various website elements. In aspects, event tracking may be directed by method calls attached to selected user interface (UI) elements. In some cases, these method calls may be included in a library. In general, queries to the event data may generate event logs for analysis. Event log analysis may provide information regarding website use, such as interactions with videos (e.g., play, stop, pause, download, download times, etc.), interactions with control elements (e.g., clicks, swipes, etc.), and the like. However, many times, event log analysis leads to additional questions and requires reevaluating and recoding method calls in order to obtain additional and/or different information regarding events.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

In an aspect, a system is provided, the system including a processor and a memory storing instructions that when executed by the processor perform a set of operations. The operations include receiving event data based at least in part on a library and generating a first collection of event data, where the first collection includes at least two identifiers and at least one asserted relationship. The operations further include receiving a first ruleset for the first collection, where one or more rules in the first ruleset are based at least in part on the at least one asserted relationship, and executing the first ruleset against the first collection to generate one or more first inferred relationships between the at least two identifiers in the first collection. Additionally, the operations include storing the one or more first inferred relationships in the first collection as an enriched first collection and, based at least in part on the one or more first inferred relationships, annotating the library.

In another aspect, a computer-implemented method for analyzing event data is provided. The method includes monitoring a resource relating to a first node in a graph and, based on the monitoring, receiving an event. The method further includes determining, based on the event, a relationship relating to the event and generating a second node in the graph. Additionally, the method includes storing the relationship as a stored relationship between the first node and the second node and evaluating an inference rule relating to the stored relationship to identify a data pattern. The method further includes providing an indication relating to the identified data pattern.

In yet another aspect, a computer storage medium is provided, the computer storage medium including computer-executable instructions that when executed by a processor perform a method of analyzing event data. The method includes monitoring a resource relating to a first node in a graph and, based on the monitoring, receiving an event. The method further includes determining, based on the event, a relationship relating to the event. Additionally, the method includes generating a second node in the graph and storing the relationship as a stored relationship between the first node and the second node. The method also includes evaluating an inference rule relating to the stored relationship to identify a data pattern and, based at least in part on the identified data pattern, modifying the inference rule.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of a first example system for generating a self-tutoring graph of event data.

FIG. 2 illustrates an overview of a second example system for generating a self-tutoring graph of event data.

FIG. 3 illustrates an overview of an example system for creating and managing a collection of event data including identifiers and corresponding relationships.

FIGS. 4A-4E illustrate an example collection of event data including identifiers and corresponding relationships.

FIG. 5A depicts a sample collection of event data having identifiers and relationships.

FIG. 5B depicts a first enriched collection of event data after executing a first version of a ruleset against the sample collection.

FIG. 5C depicts a second enriched collection of event data after executing a second version of the ruleset against the sample collection.

FIG. 6 depicts a method 600 for analyzing a collection of event data.

FIG. 7 depicts a method 700 for generating a collection of event data.

FIG. 8 depicts a method 800 for generating a self-tutoring graph of event data.

FIG. 9 depicts a block diagram illustrating example physical components of a computing device with which aspects of the disclosure may be practiced.

FIGS. 10A and 10B depict simplified block diagrams of a mobile computing device with which aspects of the present disclosure may be practiced.

FIG. 11 depicts a simplified block diagram of a distributed computing system in which aspects of the present disclosure may be practiced.

FIG. 12 depicts a tablet computing device for executing one or more aspects of the present disclosure.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure provides systems and methods of generating and querying collections of event data having identifiers and relationships between those identifiers. As used herein, event data may be tracked for various resources (e.g., websites, webpages, web elements, flash-driven elements, files, applications, emails, messages, etc.) and may be associated with identifiers including one or more of: a resource type, event type, value type, etc. For example, a resource type may include: web elements such as “button,” “scroll bar,” “cursor,” etc.; flash-driven elements such as “video”; files such as “image file,” “audio file,” “document file,” etc.; applications such as “message,” “email,” “calendar,” “task,” etc. Event types may include: for resource type “video,” an event type “download,” “play,” “pause,” etc.; for resource type “email application,” an event type “sent emails” or “received emails,” etc. Additionally, value types may include: for a “download” event type, a value type “download time” or “download clicks” or “download rate,” etc.; for “sent emails” event type, a value type “number of sent emails,” “number of sent emails to particular recipient,” etc.; and the like. Relationships identify a correlation between two or more identifiers in the collection of event data. For instance, a first identifier may be a “value type” (e.g., “download time” type) of a second identifier “event type” (e.g., “download” type). In such an example, the relationship between the value type and the event type may be “valueFor” or “valueOn,” or similar identifying text representing the relationship between the two identifiers.

In some cases, the term “identifier” includes a “resource identifier,” where resource identifiers further identify the location of a resource. A resource identifier may be a durable Uniform Resource Identifier (URI) pointing to the particular resource. The resource identifier may also be a uniform resource locator (URL), uniform resource name (URN), an internationalized resource identifier (IRI), or other suitable identifier or pointers pointing to the resource itself.

Method calls for tracking events and returning event data may be provided by a developer or other source. In some cases, the method calls may be included in a library. The event data generated based on the method calls may be referred to herein as tracked event data. In some aspects, a collection of tracked event data may be stored in a graph database in a graphical format where identifiers are displayed as nodes and the relationships are displayed as edges. As used herein, a collection of identifiers and the relationships between those identifiers may be referred as a “Set.” Queries executed against a collection of tracked event data may provide information regarding interactions of users or systems with web elements (e.g., UI elements). Each collection may also be enriched to create additional relationships and, in some examples, additional indicators, by executing a ruleset against the tracked event data already in the collection. The additional event data generated through execution of such a ruleset is referred to herein as inferred event data, such as inferred relationships and inferred identifiers. An enriched collection may also be stored in a graph database in a graphical format where tracked and inferred identifiers are displayed as nodes and tracked and inferred relationships are displayed as edges. Queries may then be executed against the enriched collection that includes both the tracked event data and inferred event data to provide richer results than would otherwise be available solely from the event data alone.

Additionally, collections (or enriched collections) of event data may be used to annotate the library of method calls. Annotations to the library may adapt the method calls to track additional or different resources and/or additional or different events relating to the resources. In some cases, annotations to the library may be generated automatically based on a collection (or an enriched collection). In other cases, annotations to the library may be based on user analysis of a collection (or an enriched collection). By annotating the library, the tracked event data may become more and more useful for providing information about interactions with web elements. In aspects, automatic annotation of the library may provide real-time feedback regarding event tracking, which upon processing may result in a self-tutoring graph of event data. Additionally or alternatively, a developer may determine that the event data should be analyzed or parsed in different ways to create more robust reports, identify trends and/or diagnose issues. In this regard, inference rules for analyzing collections of event data may be modified and honed. In aspects, annotations to the library and/or modifications to the inference rules may be continually refined in real time so as to produce the self-tutoring graph of event data. In this way, developers may create and analyze collections of event data in near real time, as well as refine such collections of event data by making modifications to the retrieval, analysis and reporting of event data in near real time. Thus, both the event data collected and the responsiveness to such event data are thereby improved.

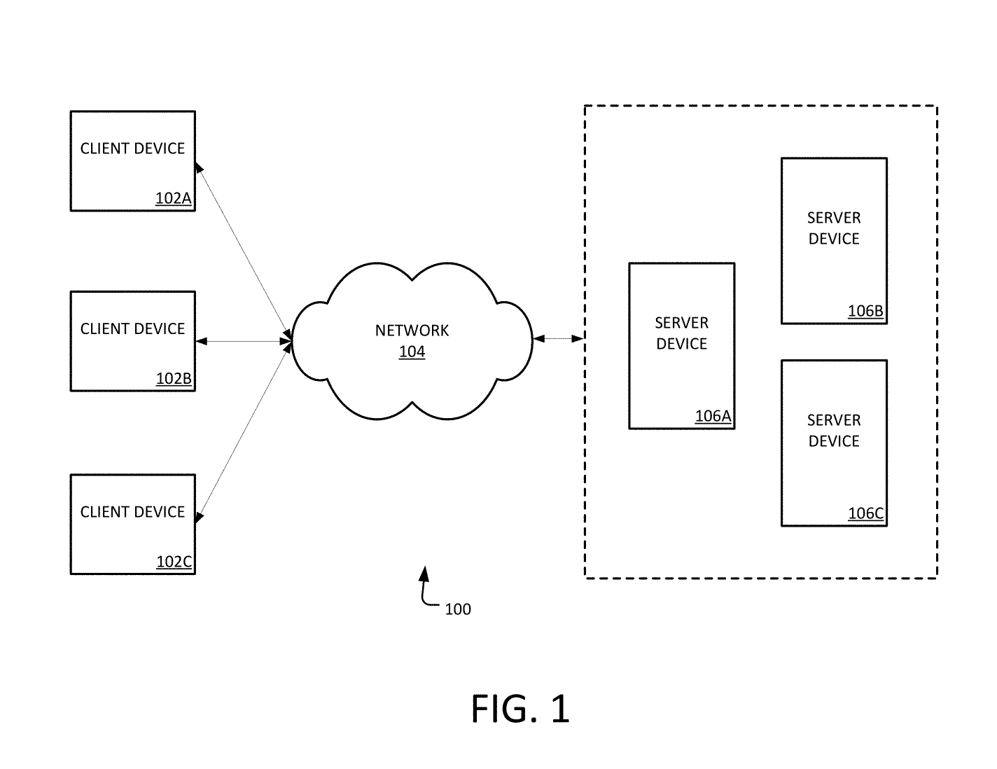

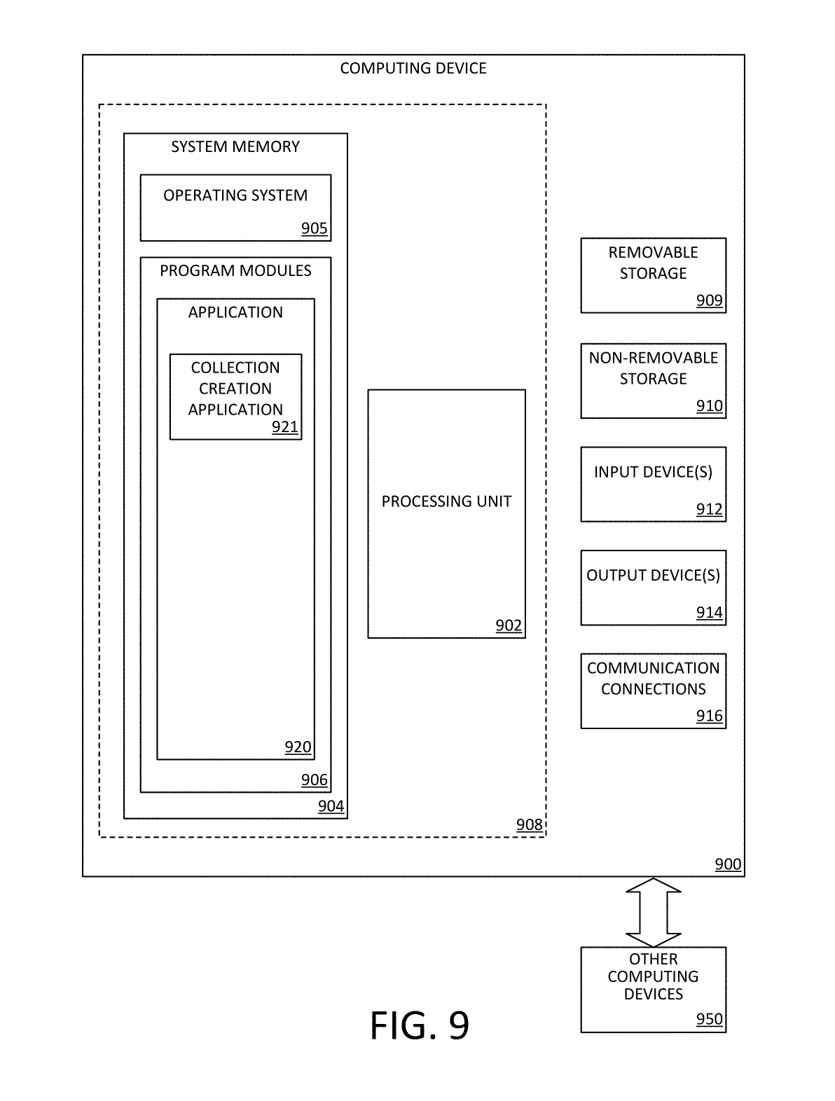

FIG. 1 illustrates an overview of a first example system for generating a self-tutoring graph of event data. Example system 100 may be a combination of interdependent components that interact to form an integrated whole for generating and querying a self-tutoring graph of event data. In aspects, system 100 may include hardware components (e.g., used to execute/run operating system (OS)), and/or software components (e.g., applications, application programming interfaces (APIs), modules, virtual machines, runtime libraries, etc.) running on hardware. In particular aspects, system 100 may provide an environment for software components to execute, evaluate operational constraint sets, and utilize resources or facilities of the system 100. In such aspects, the environment may include, or be installed on, one or more processing devices. For instance, software (e.g., applications, operational instructions, modules, etc.) may be run on a processing device such as a computer, mobile device (e.g., smartphone/phone, tablet, laptop, personal digital assistant (PDA), etc.) and/or any other electronic device. As an example of a processing device operating environment, refer to the exemplary operating environments depicted in FIGS. 9-11. In other instances, the components of systems disclosed herein may be distributed across and executable by multiple devices. For example, input may be entered on a client device and information may be processed or accessed from other devices in a network (e.g. server devices, network appliances, other client devices, etc.).

As presented, system 100 comprises client devices 102A-C, distributed network 104, and a distributed server environment comprising one or more servers, such as server devices 106A-C. One of skill in the art will appreciate that the scale of systems such as system 100 may vary and may include additional or fewer components than those described in FIG. 1. In some aspects, interfacing between components of the system 100 may occur remotely, for example, where components of system 100 may be distributed across one or more devices of a distributed network.

In aspects, client devices 102A-C may be configured to receive input via a user interface component or other input means. Examples of input may include voice, visual, touch and text input. The interface component may enable the creation, modification and navigation of various datasets and graphical representations. In examples, the various datasets may comprise (or be otherwise associated with), for example, identifiers, inferred identifiers, resource identifiers, metadata, relationships, inferred relationships, graphical mapping information, query data, rulesets, such as, for example, inference rules, etc., as discussed in further detail below. Generally, the datasets are stored on one or more server devices 106A-C and are accessible by the client devices 102A-C. In some examples, however, the datasets may be at least partially stored on one or more of the client devices 102A-C. The underlying event data represented in the various datasets (or collections) may be stored locally or in a data store, such as a cloud storage application, accessible to client devices 102A-C. In at least one example, the underlying event data represented in the various collections (or portions thereof) may be distributed across client devices 102A-C. For instance, client device 102A (e.g., a mobile phone) may locally store a first portion of the event data represented in the collection, client device 102B (e.g., a tablet) may locally store a second portion of the event data, and client device 102C (e.g., a laptop) may locally store the remaining portion of the event data represented in the collection. In examples, the client devices 102A-C may have access to all of the event data included in the collection, may have access to a subset of the event data included in the collection, or, alternatively, may not have access to any of the event data included in the collection.

As should be appreciated, the various devices, components, etc., described with respect to FIG. 1 are not intended to limit the systems and methods to the particular components described. Accordingly, additional topology configurations may be used to practice the methods and systems herein and/or some components described may be excluded without departing from the methods and systems disclosed herein.

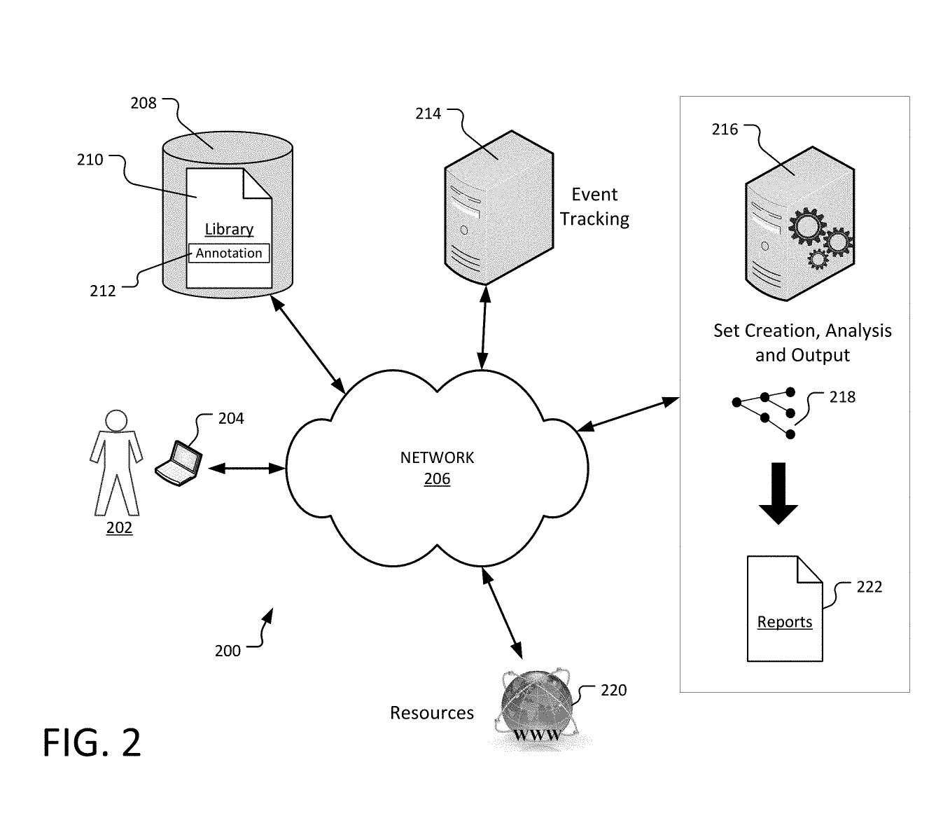

FIG. 2 illustrates an overview of a second example system for generating a self-tutoring graph of event data. Similar to example system 100, example system 200 may be a combination of interdependent components that interact to for generating and querying a self-tutoring graph of event data. In aspects, system 200 may include hardware components (e.g., used to execute/run operating system (OS)), and/or software components (e.g., applications, application programming interfaces (APIs), modules, virtual machines, runtime libraries, etc.) running on hardware. In particular aspects, system 200 may provide an environment for software components to execute, evaluate operational constraint sets, and utilize resources or facilities of the system 200. In such aspects, the environment may include, or be installed on, one or more processing devices. For instance, software (e.g., applications, operational instructions, modules, etc.) may be run on a processing device such as a computer, mobile device (e.g., smartphone/phone, tablet, laptop, personal digital assistant (PDA), etc.) and/or any other electronic device. As an example of a processing device operating environment, refer to the exemplary operating environments depicted in FIGS. 9-11. In other instances, the components of systems disclosed herein may be distributed across and executable by multiple devices. For example, input may be entered on a client device and information may be processed or accessed from other devices in a network (e.g. server devices, network appliances, other client devices, etc.).

As illustrated, system 200 may include one or more client computing devices 204 that may access a Set creation application (or a collection creation application). In some examples, a client Set creation application may execute locally on a client computing device 204. In other examples, a client Set creation application (e.g., a mobile app on a thin client computing device 204) may operate in communication (e.g., via network 206) with a corresponding server version of a Set creation application executing on one or more server computing devices, e.g., server computing device 214 and/or server computing device 216. In still other aspects, rather than executing a client version of a Set creation application, the one or more client computing devices 204 may remotely access, e.g., over network 206, the Set creation application implemented on one or more server computing devices (e.g., in a distributed computing environment such as a cloud-computing environment). In aspects, the Set creation application, whether executed on a client, a server, or in a cloud-computing environment, may be integrated into or in communication with an event tracking system or service (e.g., Azure® Event Hubs, Kafka®, or other event channel).

In a basic configuration, one or more client computing devices 204 are personal or handheld computers having both input elements and output elements operated by one or more users 202. In some instances, user 202 may be a developer, administrator, or other authorized user. For example, the one or more client computing devices 204 may include one or more of: a mobile telephone; a smart phone; a tablet; a phablet; a smart watch; a wearable computer; a personal computer; a desktop computer; a laptop computer; a television; and the like. This list is exemplary only and should not be considered as limiting. Any suitable client computing device for executing a Set creation application and/or remotely accessing a Set creation application may be utilized.

In some aspects, network 206 is a computer network such as an enterprise intranet and/or the Internet. In this regard, the network 206 may include a Local Area Network (LAN), a Wide Area Network (WAN), the Internet, wireless and wired transmission mediums. In further aspects, server computing devices (e.g., server computing devices 214, 216) may communicate with some components of the system via a local network (e.g., an enterprise intranet), whereas server computing devices (e.g., server computing devices 214, 216) may communicate with other components of the system via a wide area network (e.g., the Internet). In addition, the aspects and functionalities described herein may operate over distributed systems (e.g., cloud-computing systems), where application functionality, memory, data storage and retrieval, and various processing functions may be operated remotely from each other over a distributed computing network, such as the Internet or an intranet.

System 200 may further include storage 208. Storage 208 may be accessible to client device 204, the Set creation application, an event tracking system, one or more server computing devices (e.g., server computing devices 214, 216), etc. Storage 208 may be located in a single location or may be distributed over many locations. As illustrated, storage 208 stores a library 210, which may further include one or more annotations 212. In some aspects, library 210 comprises one or more method calls for tracking one or more machine and/or user interactions (e.g., triggers or events) on one or more resources, e.g., by an event tracking system executed by server computing device 214. Annotations 212 may further customize, refine, edit, etc., the method calls contained in library 210. However, any data may be stored at storage 208, e.g., collections of event data, raw event data, enriched collections of event data, query results, identifiers, resource identifiers, event logs, inference rules, etc.

As illustrated, server computing device 214 may be associated with an event tracking system (e.g., Azure® Event Hubs, Kafka®, Google® Analytics, or other event channel) for tracking machine and/or user interactions (e.g., events or triggers) with resources 220 (e.g., websites, webpages, web elements, flash-driven elements, files, etc.). As further illustrated, server computing device 216 may be associated with a Set creation application for creating, storing and/or processing collections of event data. For instance, server computing device 216 may process queries against event data (e.g., generated by server computing device 214) and may generate and store a collection of event data as a graph database 218. Additionally, server computing device 216 may apply inference rules to the collection of event data to generate an enriched collection of event data. In aspects, collections and enriched collections of event data may be stored as one or more graph databases 218. As should be appreciated, graph database 218 may be stored on server computing device 216, storage 208, or in any other suitable location. Server computing device 216 may further process additional queries against collections of event data and/or enriched collections of event data to produce reports 222, which may include event logs or other reports. Server computing devices 214 and 216 may be represented by any number of server computing devices, from a single server computing device to multiple server computing devices communicating over any local or wide area network, including a cloud-computing environment with distributed data storage, memory and/or processing components.

Based on the collections of event data, the enriched collections of event data and/or generated reports 222, library 210 may be annotated to adapt the method calls to track additional or different resources, resource types, event types, value types, etc., and/or additional or different relationships between identifiers. In some cases, annotations to the library may be generated automatically based on a collection, an enriched collection and/or a report. In other cases, annotations to the library may be based on user analysis of a collection, an enriched collection and/or a report. By annotating the library, the tracked event data may become more and more useful for providing information about web interactions. In aspects, automatic annotation of the library 210 may provide real-time feedback regarding event tracking, which upon processing may result in a self-tutoring graph of event data.

As should be appreciated, the various methods, devices, components, etc., described with respect to FIG. 2 are not intended to limit the systems and methods to the particular components described. Accordingly, additional topology configurations may be used to practice the methods and systems herein and/or some components described may be excluded without departing from the methods and systems disclosed herein.

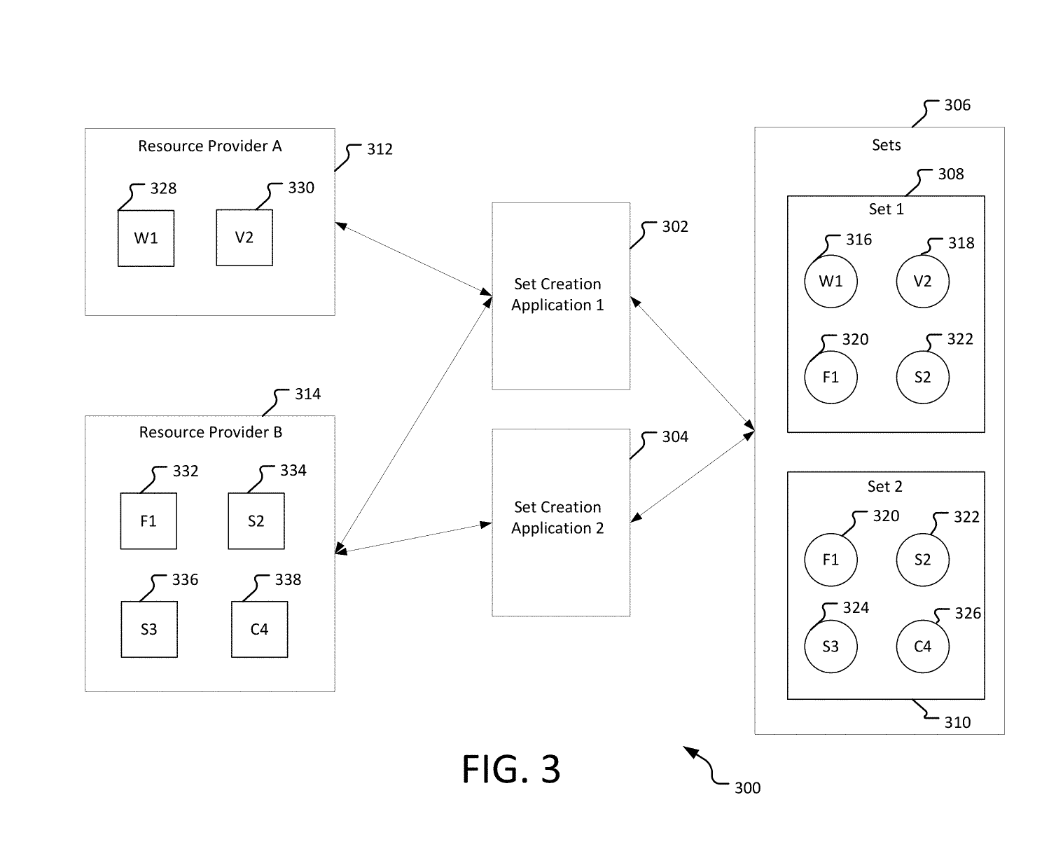

FIG. 3 illustrates an overview of an example system for creating and managing a collection of event data including identifiers and corresponding relationships. The collection techniques implemented in system 300 may comprise or be associated with a single computing device (comprising one or more components such as processors and/or memory) or multiple computing devices, which may perform the processing described in systems 100 and 200, respectively.

With respect to FIG. 3, system 300 may comprise Set creation applications 302 and 304; Set environment 306; Sets 308 and 310; resource providers 312 and 314; identifiers 316, 318, 320, 322, 324 and 326; and event data 328, 330, 332, 334, 336 and 338. In aspects, Set creation applications 302 and 304 may be an application or service configured to create, infer, manipulate, navigate and visualize various identifiers, relationships and graphical representations. Set creation applications 302 and 304 may define collections of relationships between event data and executing queries on those collections. Set creation applications 302 and 304 may further provide for defining and storing rulesets used to infer one or more relationships in the collections, and for displaying graphical representations of the collections of event data. The defined rulesets may be stored in the Set itself, and in some examples stored as metadata within the Set. In examples, Set creation applications 302 and 304 may be installed and executed on a client device or on one or more devices in a distributed environment. For instance, with reference to FIG. 1, Set creation application 302 may be installed on client device 102A, Set creation application 304 may be installed on client device 102B, and a Set creation service associated with server device 106A may be accessible to client device 102C.

In aspects, Set creation applications 302 and 304 may have access to a file directory or an execution environment, such as environment 306. Environment 306 may be collocated with a Set creation application, or environment 306 may be located remotely from the Set creation application. Environment 306 may provide access to one or more event data collections, such as Sets 308 and 310. In examples, access to the event data collections may be determined using one or more sets of permissions generated and/or maintained by Set creation applications 302 and 304. The sets of permissions may be different across one or more of the event data collections. As a result, one or more of the event data collections (or functionality associated therewith) may not be accessible from one or more of Set creation applications 302 and 304.

Sets 308 and 310 may respectively comprise isolated collections of identifiers and corresponding relationships. The relationships in the isolated collections may be defined manually or may be automatically derived using one or more rulesets. The isolated collections may be represented using graphical structures, such as nodes and edges, which directly relate events in the isolated collection and provide for retrieving relationship data with a single operation. Each isolated collection may comprise identifiers that are unique to that collection. Alternately, the isolated collections may comprise identifiers included in one or more alternate isolated collections. For example, as depicted in FIG. 3, Set 308 may comprise identifiers 316, 318, 320 and 322, and Set 310 may comprise identifiers 320, 322, 324 and 326.

Identifiers 316, 318, 320, 322, 324 and 326 may correspond to, and/or identify the location of, one or more resources. In this case, the identifier may be a resource identifier that references an existing resource, but is not itself a resource. Exemplary types of resource identifiers include, but are not limited to, a Uniform Resource Identifier (e.g., a Uniform Resource Locator (URL), a Uniform Resource Name (URN) etc.), an IP address, a memory or storage address, and the like. One of skill in the art will appreciate that any type of identifier may be employed by the various aspects disclosed herein without departing from the scope of this disclosure. Identifying the location of a resource may include parsing the resource identifier using, for example, regular expressions, providing one or more portions of the resource identifier to a search utility, executing the resource identifier, etc. In aspects, having access to the data collections does not guarantee access to the resources identified by the resource identifiers included in each data collection. For example, although a user may be able to access and manipulate Set 308, the user may not be authorized to access one or more of the underlying resources corresponding to the resource identifier in Set 308.

Resource providers 312 and 314 may be configured to store and/or provide access to one or more resources. As such, a resource provider as used herein may be a website host, a social media host, an event tracking system, a data store, a cloud service provider, a client computing device, a server computing device, a distributed system of devices such as, for example, an enterprise network, an application, a software platform (e.g., an operating system, a database, etc.), and the like. In aspects, resource providers 312 and 314 may be (or have access to) various different data sources, such as websites, event channels, content providers, data stores, various sets of application data, and the like. For example, as depicted in FIG. 3, resource provider 312 may be an event tracking service that tracks different types of resources such as resource 328 (e.g., web element 1 (W1)) and resource 330 (e.g., flash-driven element 2 (V2)) and resource provider 314 may be website host associated with various social media resources 332 (e.g., file 1 (F1)), 334 (e.g., social post 2 (S2)), 336 (e.g., social post 3 (S3)) and 338 (e.g., contact 4 (C4)). In this example, resource identifier 316 may correspond to resource 328; resource identifier 318 may correspond to resource 330; resource identifier 320 may correspond to resource 332; resource identifier 322 may correspond to resource 334; resource identifier 324 may correspond to resource 336; and resource identifier 326 may correspond to resource 338. In some aspects, resource providers 312 and 314 may be accessible by Set creation applications 302 and 304. Set creation applications 302 and 304 may access resource providers 312 and 314 to determine the existence of resources and/or retrieve information associated with the resources (e.g., resource metadata, resource location, resource identifiers, permission sets, authentication data, etc.). The information retrieved from resource providers 312 and 314 may be used to determine a set of resource identifiers corresponding to one or more of the available resources. The set of resource identifiers may be used to create one or more isolated collections of resource identifiers and corresponding relationships.

As noted above, a resource identifier may be, or include, a durable URI for a corresponding resource. For instance, the resource identifier 316 may include the URL for a website and a URI for the actual web element (W1) 328. Accordingly, in such an example, a user is able to determine the location of the web element (W1) 328 from the Set, and, depending on authentication and access restrictions, retrieve information regarding the web element (W1) 328. As another example, as depicted in FIG. 3, resource provider 312 may be accessed by Set creation application 302. Set creation application 302 may determine that resource provider 312 comprises at least resources 328 and 330, and may determine resource identification information for each of the resources. Based on the determined resource identification information, resource identifiers 316 and 318 may be respectively applied/correlated to resources 328 and 330, and provided to environment 306. Environment 306 may then make resource identifiers 316 and 318 eligible for an inclusion analysis into one or more isolated collections. In at least some cases, identifiers may not include information regarding a source or location of a resource but may be associated with information regarding a resource (e.g., a resource type such as a “button” type or a “video” type).

As should be appreciated, the various methods, devices, components, etc., described with respect to FIG. 3 are not intended to limit the systems and methods to the particular components described. Accordingly, additional topology configurations may be used to practice the methods and systems herein and/or some components described may be excluded without departing from the methods and systems disclosed herein.

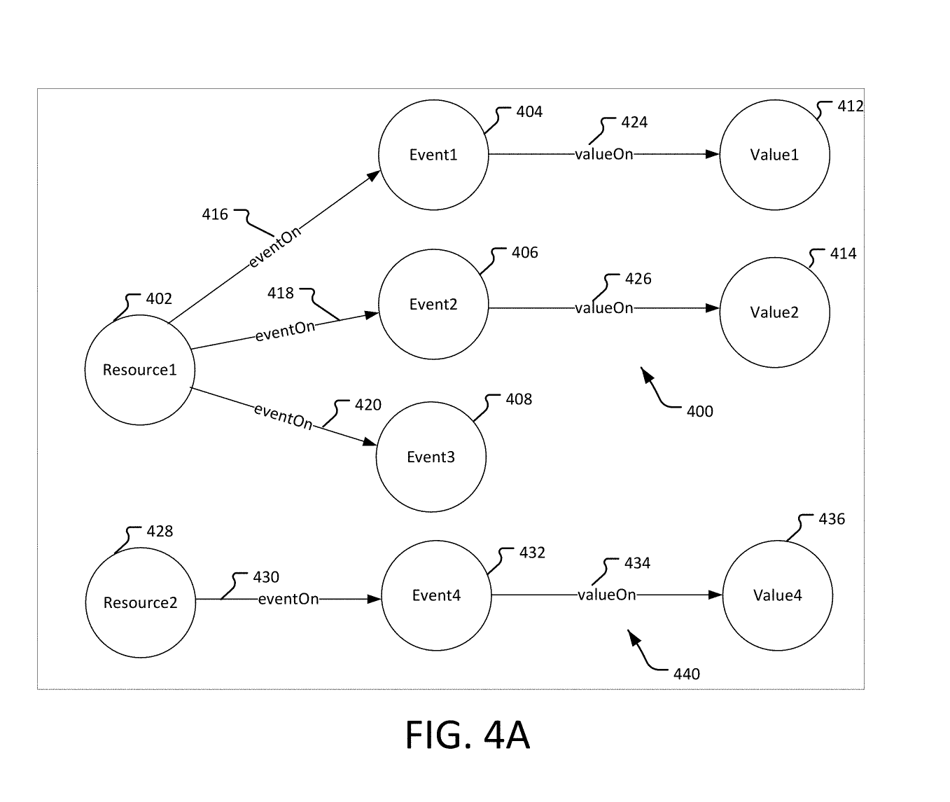

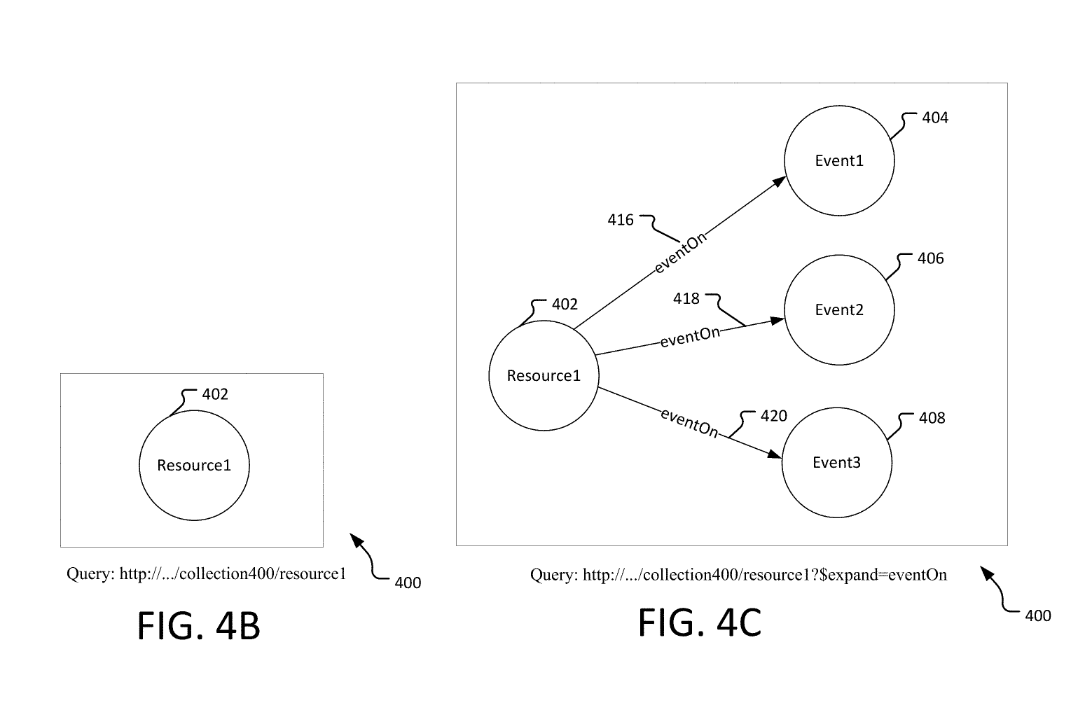

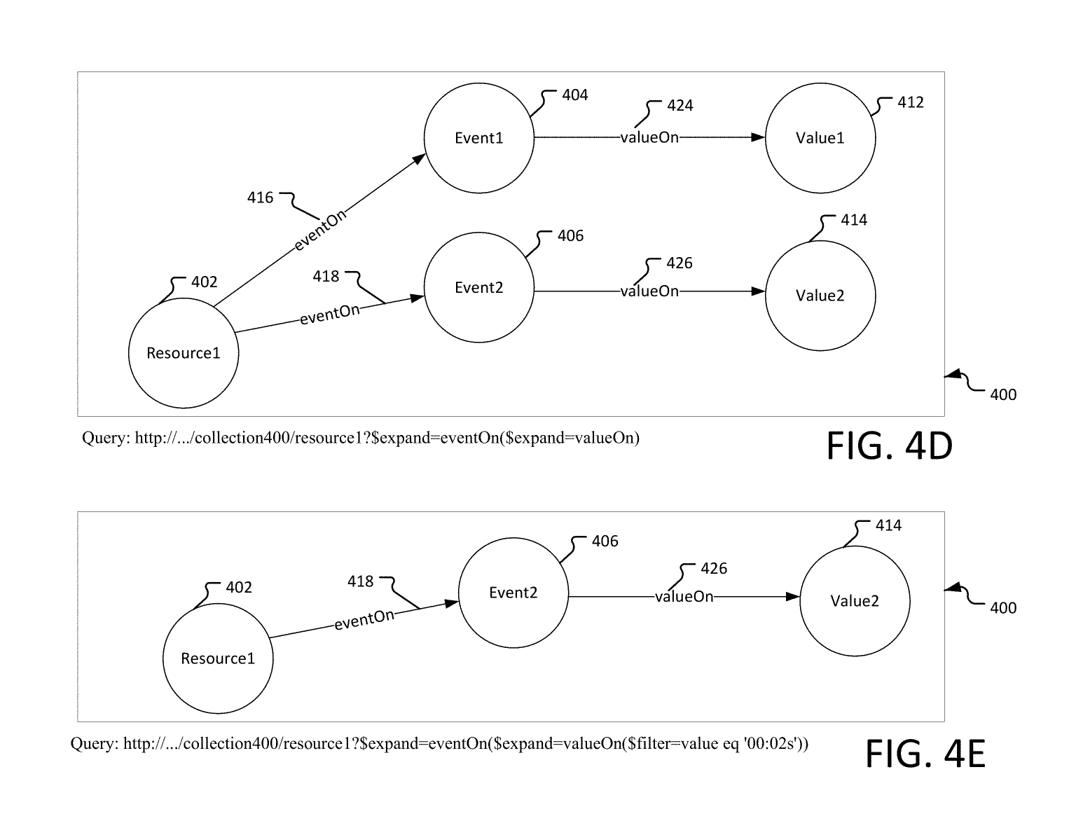

FIGS. 4A-4E illustrate an example collection of event data including identifiers and corresponding relationships. FIG. 4A illustrates an example collection 400 of identifiers and corresponding relationships. Example collection 400 comprises identifiers 402, 404, 406, 408, 412, and 414, and relationships 416, 418, 420, 424 and 426. In aspects, collection 400 may be generated and/or manipulated using a collection creation utility that may be included as part of a Set creation application (or a collection creation application) as discussed above. When presented in graph form as depicted in the FIG. 4A, each identifier may be referred to as a “node” and each relationship may be referred to as an “edge.” The collection creation utility may also identify resources and/or determine resource types for collections using one or more rulesets that may include rules defined in accordance with semantic web technologies, such as resource description framework (RDF), RDF schema (RDFS), SPARQL Protocol and RDF Query Language (SPARQL), Web Ontology Language (OWL), etc. For example, collection 400 includes an identifier 412 that represents underlying data, “Value1” in the depicted example. Similarly, identifier 404 represents an event, “Event1,” and identifier 402 represents a resource, “Resource1.” For instance, Event1 may be a first “download” event type on Resource 1 (e.g., a flash-driven element of type “video”) and Value1 may be the “download time” value type on Event 1. Identifier 406 represents a second event, “Event2,” with a second value, “Value2,” on Resource 1. In this case, Event2 may be a “pause” event type and corresponding identifier 414 may be the “pause time” value type on Event2.

In aspects, each of the identifiers and relationships included in the collection 400 may have been asserted by a developer through a Sets creation application. In this case, the identifiers and relationships may be referred to herein as “asserted identifiers” and/or “asserted relationships.” For instance, a developer may manually add each of the identifiers and the relationships between the identifiers. As an example, the developer may manually indicate that the “Event1” is an event on “Resource1,” as represented in the collection 400 by the “eventOn” relationship 416. Alternatively, the identifiers and relationships may be generated and asserted by an event tracking system. Alternatively still, the identifiers and relationships may be asserted by an external bot or application created by a developer. For instance, an add-in may be programmed to monitor activity in a browser or other application to track usage of the application. Based on the usage of the application, the add-in sends additional resources and relationships to be included in the collection 400.

In contrast to the asserted identifiers and asserted relationship, a collection creation utility may execute a ruleset to determine additional relationships and resource types, referred to herein as “inferred relationships” and “inferred identifiers” or “inferred types.” Generation of inferred relationships and inferred identifiers is discussed in further detail below.

Collection 400 further depicts identifier 402 associated with identifiers 404, 406 and 408. The collection creation utility may determine that the identifiers 404, 406 and 408 represent events on (e.g., triggers on) identifier 402. In a different example than described above, it may be determined that identifier 406 (e.g., Event2) may be a second “download” event type on identifier 402 (Resource1, e.g., flash-driven element of “video” type) with a second value (e.g., Value2) associated with identifier 414 that may be a “download time” value type. Based on this determination, the collection creation utility may assign (or infer) relationship 418 (e.g., “eventOn”) to define the association between identifier 402 and identifier 406, and may assign relationship 426 (e.g., “valueOn”) to define the association between identifier 406 and identifier 414. In aspects, identifiers 412 and 414 may be associated with different download times for the separate download events on the flash-driven element. In other examples, the relationships 418 and 426 may be asserted, as discussed above. Collection 400 further illustrates identifier 402 (e.g., Resource1) with relationship 420 (e.g., “eventOn”) to identifier 408 (e.g., Event3). For instance, Event3 may be a “stop” event type on Resource1. In aspects, the stop event may not be associated with a value.

As further illustrated, collection 440 depicts identifier 428 (e.g., Resource2) with relationship 430 (e.g., “eventOn”) to identifier 432 (e.g., Event4). Collection 440 further illustrates identifier 432 (e.g., Event4) with relationship 434 (“valueOn”) to identifier 436 (e.g., Value4). In this case, Resource2 may be a web element of a “button” type, Event4 may be a “button click” event, and Value4 may be a “number” of button click events. While specific types of resources and relationships are described in FIG. 4A, one of skill in the art will appreciate that other types of resources and/or relationships may be included in an isolated collection without departing from the spirit of this disclosure.

FIGS. 4B-4E illustrate an example query model that may be used to traverse collection 400. In aspects, queries may be executed via an interface provided by the collection creation utility. A query may be executed against one or more files and/or directories comprising information, such as identifiers, resources, resource types, resource metadata, permission data, event data, etc. The query results may be visualized in a graph form as one or more collections, such as collection 400. For example, the entire collection 400 dataset may comprise only those elements illustrated in collection 400 (e.g., identifiers 402, 404, 406, 408, 412 and 414 and relationships 416, 418, 420, 424 and 426). In this particular example, resource identifier 412 may represent a value (e.g., Value1, e.g., of value type “download time” in seconds) for an identifier 404 representing an event (e.g., Event1, e.g., of a “download” event type) on an identifier 402 representing a resource (e.g., Resource1, e.g., of a resource type “video”). The query ‘http:// . . . /collection400/resource1’ may be executed against collection 400. The query results may comprise identifier 402 and be visualized as illustrated in FIG. 4B.

In FIG. 4C, the query has been amended to ‘http:// . . . /collection400/resource1?$expand=eventOn’ and executed against collection 400. The query results may comprise identifiers 402, 404, 406 and 408 and relationships 416, 418 and 420, and be visualized as illustrated in FIG. 4C. In FIG. 4D, the query has been amended to ‘http:// . . . /collection400/resource1?$expand=eventOn($expand=valueOn)’ and executed against collection 400. The query results may comprise identifiers 402, 404, 406, 408, 412 and 414 and relationships 416, 418, 424 and 426, and be visualized as illustrated in FIG. 4D. In FIG. 4E, the query has been amended to ‘http:// . . . /collection400/resource1?($expand=eventOn($expand=valueOn($filter=value eq ‘00:02s’))’ and executed against collection 400. In this example, only identifier 414 comprises a value for download time of “2 seconds,” so the query results comprise identifiers 402, 406 and 414 and relationships 418 and 426, and is visualized as illustrated in FIG. 4E.

As should be appreciated, the various methods, devices, components, etc., described with respect to FIGS. 4A-4E are not intended to limit the systems and methods to the particular components described. Accordingly, additional topology configurations may be used to practice the methods and systems herein and/or some components described may be excluded without departing from the methods and systems disclosed herein.

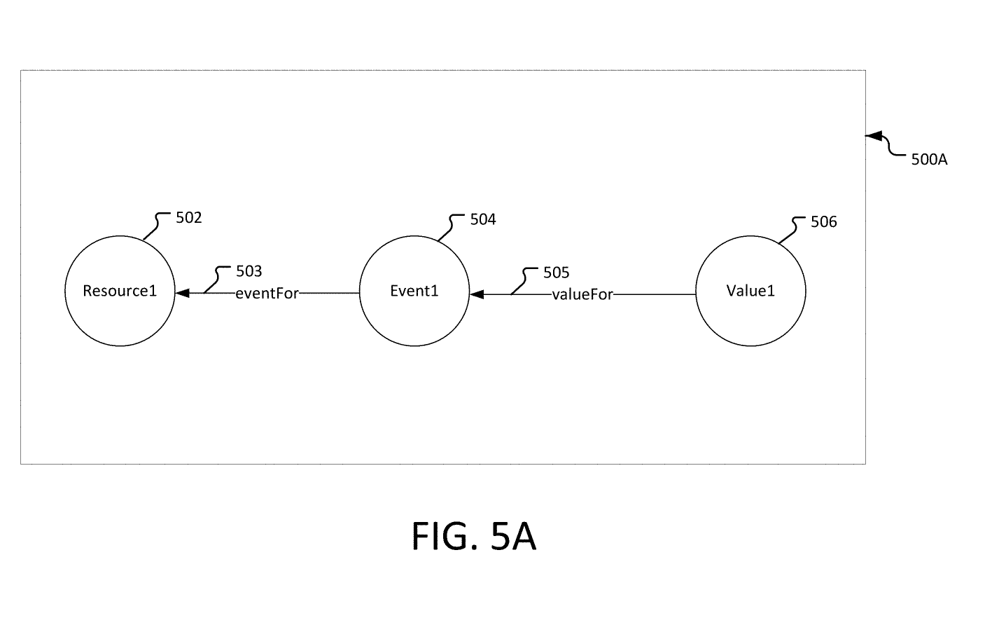

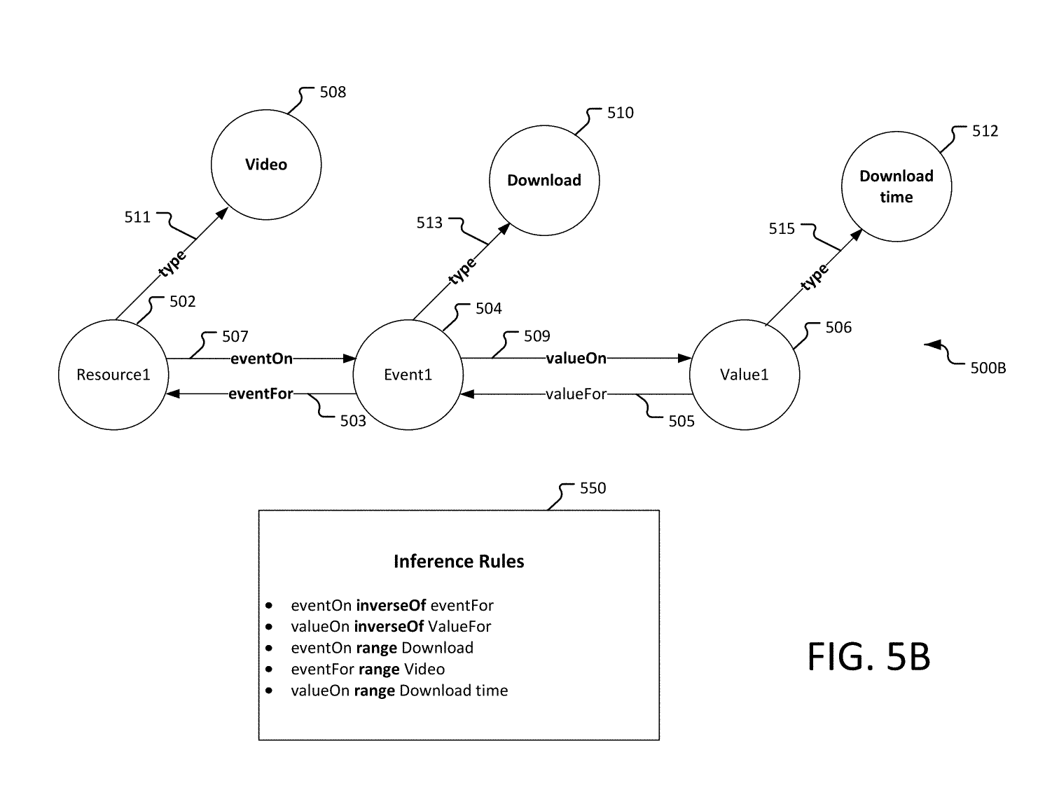

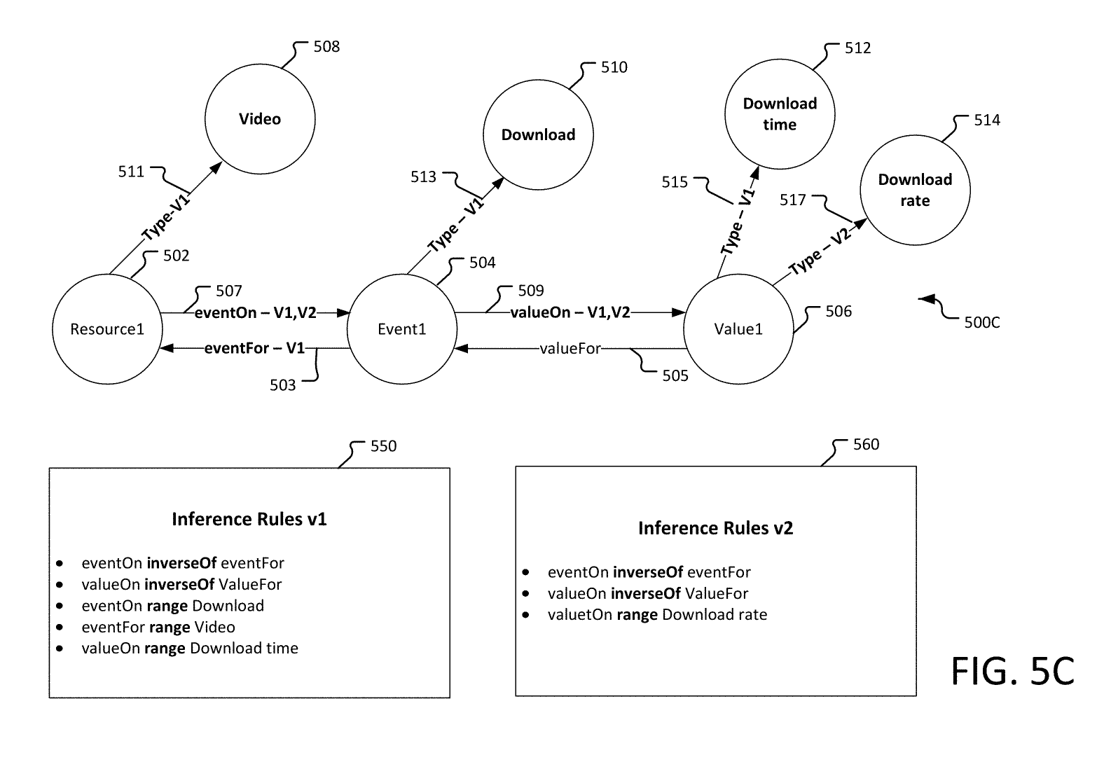

FIG. 5A depicts a sample isolated collection of event data having identifiers and relationships. More specifically, the isolated collection 500A includes three identifiers—identifier 502 representing Resource1 (e.g., a flash-driven element), identifier 504 representing Event1 (e.g., a “download” event type) and identifier 506 representing Value1 (e.g., a “download time” value type). A relationship 503 of “eventFor” exists between identifier 504 and identifier 502. In utilizing terminology from the Web Ontology Language (OWL), the domain of the relationship 503 is identifier 504 and the range of relationship 503 is identifier 502. Thus, the relationship 503 is directional in that it indicates that “Event1” is an event for “Resource1,” rather than the other way around. A relationship 505 of “valueFor” also exists between identifier 506, and relationship has a range of resource identifier 504 and a domain of resource identifier 506. Like relationship 503, relationship 505 is also directional, e.g., relationship 505 states that “Value1” is a value for “Event1,” rather than the other way around. While the data depicted in in isolated collection 500A in FIG. 5A is useful on its own, it would be more beneficial to be able to enrich the data to provide further insights and allow for richer queries to be performed on the data. For instance, in utilizing expand query types, expansions of the graph visualizations could only occur in one direction. That is, expansion would not be possible if the expansion process started with resource identifier 502, due to the directional relationship 503. By executing a ruleset against the isolated collection 500A, however, additional data may be generated and directionality problems may be resolved.

FIG. 5B depicts a first enriched collection 500B of event data after executing a first version of a ruleset 550 against the sample collection 500A. As discussed above, ruleset 550 may be provided by a developer through a developer user interface. Accordingly, different rulesets may be provided for different isolated collections. Further, the rulesets are also fully customizable for each of the isolated collections such that the developer may generate any types of rules that suitable for the particular application.

The ruleset 550 includes the following rules: (1) “eventOn” inverseOf “eventFor;” (2) “valueOn” inverseOf “valueFor;” (3) “eventOn” range “Download;” (4) “eventFor” range “Video”; and (5) “valueOn” range “Download time.” Rule (1) “eventOn” inverseOf “eventFor” establishes that a relationship “eventOn” is the inverse of the relationship “eventFor.” Each of the rules in the ruleset is based on the value of at least one of the relationships in the isolated collection. Upon executing Rule (1) against the isolated collection 500A, an additional relationship 507 of “eventOn” is generated, having the inverse direction of the “eventFor” relationship 503. For instance, the event on relationship 507 has a range of “Event1” and a domain of “Resource1” to indicate that “Event1” is an event on “Resource1.” Rule (2) is similar to Rule (1) in that it generates an inverse of a relationship. In particular, Rule 2 generates a “valueOn” relationship 509 based on the “valueFor” relationship 505. The “valueOn” relationship 509 has a direction opposite that of the “valueFor” relationship 505.

Rules (3), (4) and (5) determine a type or class of identifier based on a relationship that either has a domain or range of the particular identifier. For example, execution of Rule (3) causes a “type” relationship 513 to be created as well as type node 510 that indicates the type of Event1 is “Download.” It follows that execution of Rule (3) establishes that the range of the “eventOn” relationship is “Download.” Rule (4) is similar to Rule (3) in that it establishes a type of an identifier based on a relationship that has a range of that identifier. In particular, execution of Rule (4) also causes a “type” relationship 511 to be created as well as type node 508 that indicates the type “Video.” In this case, the range of the relationship “eventFor” is “Video.” Rule (5) is similar to Rules (3) and (4) in that it also establishes a type of an identifier based on a relationship that has a range of that identifier. In particular, execution of Rule (5) causes a “type” relationship 515 to be created as well as type node 512 that indicates the type “Download time.” In this case, the range of the relationship “valueOn” is “Download time.” In other examples, a new node need not be created to establish the type of the identifier when executing rules similar to Rules (3), (4) and (5). Rather, a class may be established for the particular type and then associated with the respective identifier or a type may be established within the data representing the identifier itself.

As illustrated, by executing such a ruleset 550 against the isolated collection 500A, additional inferred data is created within the isolated collection 500A to generate the enriched isolated collection 500B. With the additional inferred data in the enriched isolated collection 500B, richer queries may be run against the enriched isolated collection 500B. For instance, expand queries may be executed from any identifier in the enriched isolated collection 500B. Further, queries regarding the type of resource indicators in the isolated collection may also be performed.

The present technology also provides for updating rulesets to create multiple versions of rulesets. For instance, a developer may determine that a particular ruleset is insufficient for a particular purpose or that the rules in the ruleset lead to incorrect data being generated within an isolated collection. For instance, a developer may determine that additional or different event data should be gathered. Additionally or alternatively, a developer may determine that the event data should be analyzed or parsed in different ways to create more robust reports to identify trends and/or diagnose issues. In this regard, annotations may be made to a library, e.g., library 210, in order to collect and/or retrieve additional or different event data from an event tracking service or other event channel. Additionally or alternatively, inference rules for analyzing collections of event data may be modified and honed. In aspects, annotations to the library and/or modifications to the inference rules may be continually refined in real time so as to produce a self-tutoring graph of event data. Such a self-tutoring graph of event data provides benefits over prior systems, enabling developers to create and analyze collections of event data in near real time, as well as enabling developers to refine such collections by facilitating prompt modifications to the retrieval, analysis and reporting of event data. In this way, both the event data collected and the responsiveness to such event data are thereby improved.

When multiple versions of rulesets are generated, the later versions may not be backward compatible with the earlier versions and earlier versions may not be compatible with the later versions. However, updates to rulesets do not always correspond to updates to application programming interfaces (APIs) or user applications accessing the isolated collections. For example, a developer may update a ruleset to a new version and also provide an update to an API or external application, but the user may not download or accept the new update to the API. Accordingly, users that are operating a prior version of an API or application would submit queries based on a ruleset of a corresponding to previous version of the ruleset. Where the rulesets are not backwards compatible, execution of the query may result in an error or query results that are incomplete or misleading. Thus, there is a need for handling multiple versions of rulesets such that queries received from different versions of APIs and applications are executed against data generated by the correct corresponding ruleset.

The present technology provides multiple solutions to such problems, among others. In an example, when a ruleset is executed against an isolated collection, any inferred relationships that are generated are marked with a version number. As such, the data that has been inferred may be identified and then filtered based on the version number of the ruleset, and queries are able to return results that correspond to the particular API or application version, despite other versions of rulesets having been created.

FIG. 5C depicts a second enriched collection 500C of event data after executing a second version of the ruleset against the sample collection 500A. The enriched isolated collection 500C resulted from executing Ruleset (Version 1) 550 and Ruleset (Version 2) 560 against the asserted resources and relationships in isolated collection 500A depicted in FIG. 5A. Ruleset (Version 2) 560 may be a ruleset that has been updated by a developer.

Ruleset (Version 2) 560 includes the following rules: (1) “eventOn” inverseOf “eventFor;” (2) “valueOn” inverseOf “valueFor;” (3) “valueOn” range “Download rate.” The first two rules of Ruleset (Version 1) 550 and Ruleset (Version 2) 560 are the same, but the third and fourth rules are not present in Ruleset (Version 2) 560 and the third rule of Ruleset (Version 2) 560 differs from the fifth rule in Ruleset (Version 1) 550. Accordingly, some of the inferred relationships and inferred nodes differ depending on the ruleset that is executed. Thus, for each inferred relationship or node generated by a particular ruleset, a version identifier is generated for each respective inferred relationship or node to indicate which version of the ruleset caused the creation of the respective inferred relationship or node. Where two or more versions of the ruleset cause the creation of the same inferred relationship or node, that relationship or node may be stamped with multiple version identifiers. The version identifier may be the version number or version name of the particular ruleset or in other examples may be a timestamp indicating when the ruleset was executed against the isolated collection 500A, as discussed further below.

As an example, execution of Ruleset (Version 1) 550 results in the creation of inferred relationship 503, inferred relationship 507, inferred relationship 509, inferred relationship 511, type node 508, inferred relationship 513, the type node 510, inferred relationship 515, and type node 512, as discussed above with reference to FIG. 5B. Each of the inferred relationships are marked with a version identifier as shown in FIG. 5C, which in the example depicted is the version number of the ruleset. Execution of Ruleset (Version 2) 560 also results in the creation of inferred relationship 507 and inferred relationship 509. As such, inferred relationship 507 and inferred relationship 509 is also marked with a version identifier for Ruleset (Version 2) 560. Execution of Ruleset (Version 2) 560 also creates inferred relationship 517 and type node 514 to establish that the identifier Value1 506 is of a “download rate” type. Inferred relationship 517 and type node 514 are marked with a version identifier for Ruleset (Version 2) 560.

By marking each of the generated inferred queries with the respective version identifiers, results to queries may be filtered based on the appropriate ruleset. For instance, upon receiving a query, a query identifier may be extracted from the query. From the query identifier, the appropriate ruleset version may be ascertained, as discussed in further detail below. By marking each of the inferred relationship with a version number, additional technical benefits are also realized. As an example, there is no need to store multiple versions of the isolated collection itself. For instance, without versioning the inferred edges and nodes themselves, multiple isolated collections would be need to be stored, e.g., one for each version of the ruleset. Storing multiple versions of a database, however, results in significant issues with having to synchronize the asserted data across each of those isolated collections. If an asserted reference were to be added or updated in one version of the isolated collection, that update or addition would need to be synchronized across all versions of isolated collections. By versioning the inferred edges with the present technology, such technical problems are avoided.

Further, when any portion of an enriched isolated collection, such as enriched isolated collection 500B and enriched isolated collection 500C, is displayed to a user, the inferred relationships and nodes may be displayed in a different manner than the asserted resource identifiers and relationships. For instance, the inferred relationships and nodes may be shown in bold and the asserted resources and relationships may be shown un-bolded, as shown in FIGS. 5B and 5C. Other differentiating characteristics may include font color, highlighting, underlining, italicizing, shape of edges and/or connectors, and other similar differentiating characteristics. Thus, a user viewing the isolated set, or a portion thereof a result to a query, is able to distinguish between the asserted and inferred data.

As should be appreciated, the various methods, devices, components, etc., described with respect to FIGS. 5A-5C are not intended to limit the systems and methods to the particular components described. Accordingly, additional topology configurations may be used to practice the methods and systems herein and/or some components described may be excluded without departing from the methods and systems disclosed herein.

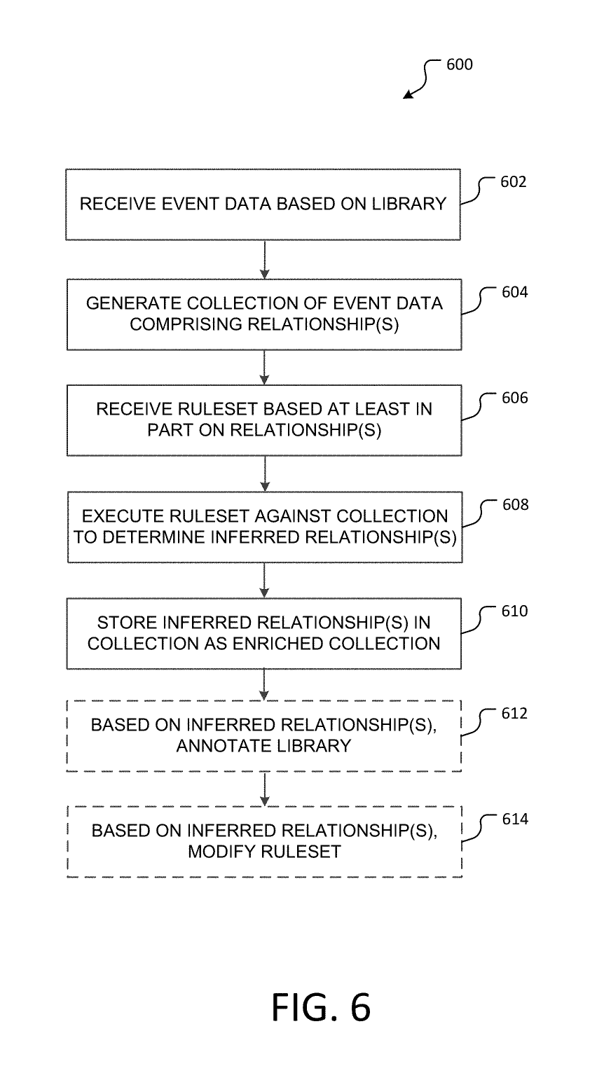

FIG. 6 depicts a method 600 for analyzing a collection of event data. Method 600 begins at operation 602 where event data is received. As detailed above, the event data may be received from an event tracking service or other event channel. In aspects, event data may be tracked for various resources (e.g., websites, webpages, web elements, flash-driven elements, files, etc.). In some cases, the system analyzing the event data may also collect (or track) the event data. In further aspects, a library may dictate or define the event data that is received and/or collected.

At generate operation 604, a collection of event data may be generated. When generating the collection of event data, identifiers associated with the event data may be extracted, including one or more of: resource type (e.g., web elements of “button” type, “scroll bar” type, “cursor” type; flash-driven elements of “video” type; files of “image file” type, “audio file” type, “document file” type, etc.), event type (e.g., for resource type “video,” event types may include a “download” type, a “play” type, a “pause” type, etc.), value type (e.g., for a “download” type, a value type may be “download time” or “download clicks” or “download rate,” etc.), and the like. Additionally, relationships that represent a correlation between two or more identifiers within the event data may be determined. For instance, a first identifier may be a “value type” (e.g., “download time” type) of a second identifier “event type” (e.g., “download” type). In such an example, the relationship between the value type and the event type may be “valueFor” or “valueOn,” or similar identifying text representing the relationship between the two identifiers.

The relationships and/or identifiers may be asserted by developer directly, or they may be asserted by an external bot or application created by a developer. For instance, an add-in may be programmed to monitor activity in a browser or other application to track usage of the application. Based on the usage of the application, the add-in selects resources and/or events for monitoring for inclusion in the collection. In some cases, a query may be received against the event data. The query may in the form of the queries discussed above with reference to FIGS. 4A-4E. Based on the query, a graph may be generated including nodes representing resources (or events tracked for the resources) and edges between the nodes representing relationships. In examples where a query is received at operation 604, the graph may be generated in response to the query. In such an example, the graph includes the results to the query.

In some aspects, relationships within the collection of data may be “asserted” relationships. That is, the relationships may be defined or determined by a developer and/or by machine analysis of the event data. In other aspects, relationships within the collection of data may be “inferred” relationships. That is, the relationships may be determined by applying inference rules to the collection of event data. As should be appreciated, relationships between identifiers within the collection of event data may provide information regarding the event data. Thus, queries may also be executed against the collection of event data to generate reports and/or event logs for identifying trends, analyzing system usage, diagnosing issues, monitoring network activity, and the like.

At receive ruleset operation 606, a ruleset for the collection of event data may be received. In some cases, the ruleset may be selected based in part on the one or more relationships within the collection of event data. As detailed above, a ruleset may be used to infer one or more relationships in a collection of event data. The defined rulesets may be stored in the Set itself, and in some examples stored as metadata within the Set. A ruleset may be provided by a developer through a developer user interface. Accordingly, different rulesets may be provided for different collections of event data. Further, rulesets may be fully customizable for each collection such that the developer may generate rules that are suitable for a particular application or use of the event data.

At execute ruleset operation 608, the ruleset is executed against the collection of event data to generate inferred data. The inferred data may include inferred relationships and/or inferred type nodes. In some examples, operation 608 may be triggered upon receiving the ruleset or a selection of the ruleset. Operation 608 may also be triggered upon the addition or alteration of any event data within the collection. As detailed above, a rule of a ruleset may determine a type or class of an identifier based on a relationship that either has a domain or range of the particular identifier. For example, for a particular identifier, a “type” relationship may be created as well as a type node within the graph that indicates the type for the identifier.

At store inferred relationships 610, the inferred relationships may be stored in the collection of event data as an enriched collection of event data. Alternatively, the inferred relationships may be maintained separately from asserted relationships in the collection of event data. For example, the inferred data may be marked so as to indicate its inferred status, or it may be stored in a separate portion of memory. By separately maintaining the inferred data from the asserted data, deletion of asserted data upon execution of the ruleset may be prevented. For instance, a ruleset may include rules that would change or delete a particular identifier or relationship. Such changes, in some examples, may be prevented when the identifier or relationship is asserted. In some examples, execution of the ruleset may take a substantial amount of time and queries may not be executed against the collection of event data during that time. As such, once the execution of the ruleset is complete and the inferred data is stored, operation 610 may further include sending a notification that execution of the ruleset is complete, thus indicating queries are being accepted against the enriched collection of event data.

At optional annotate operation 612, based at least in part on the inferred relationships, a library may be annotated. As discussed above, annotations to the library may adapt method calls for tracking additional or different event data and/or additional or different identifiers or relationships associated with the event data. The method calls may be implemented by a collection creation application (or a Set creation application) to track event data or to send tracking instructions to an event tracking service for collecting event data. In some cases, annotations to the library may be generated automatically based on a collection (or an enriched collection) of event data. In other cases, annotations to the library may be based on user analysis of a collection (or an enriched collection). By annotating the library, the tracked event data may become more and more useful for providing information about interactions with web elements. In aspects, automatic annotation of the library may provide real-time feedback regarding event tracking, which upon processing may result in a self-tutoring graph of event data.

At optional modify operation 614, based at least in part on the inferred relationships, one or more rules of the ruleset may be modified. For instance, a developer may determine that the event data should be analyzed or parsed in different ways to create more robust reports, identify problems and/or diagnose issues. In this regard, inference rules for analyzing collections of event data may be modified and honed. That is, the ruleset may be modified to identify additional or different inferred data based on the collection of event data. In aspects, modifications to the inference rules may be continually refined in real time so as to produce the self-tutoring graph of event data. In this way, developers may continually enrich collections of event data by making modifications to the inferences determined for the event data.

As should be appreciated, operations 602-614 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

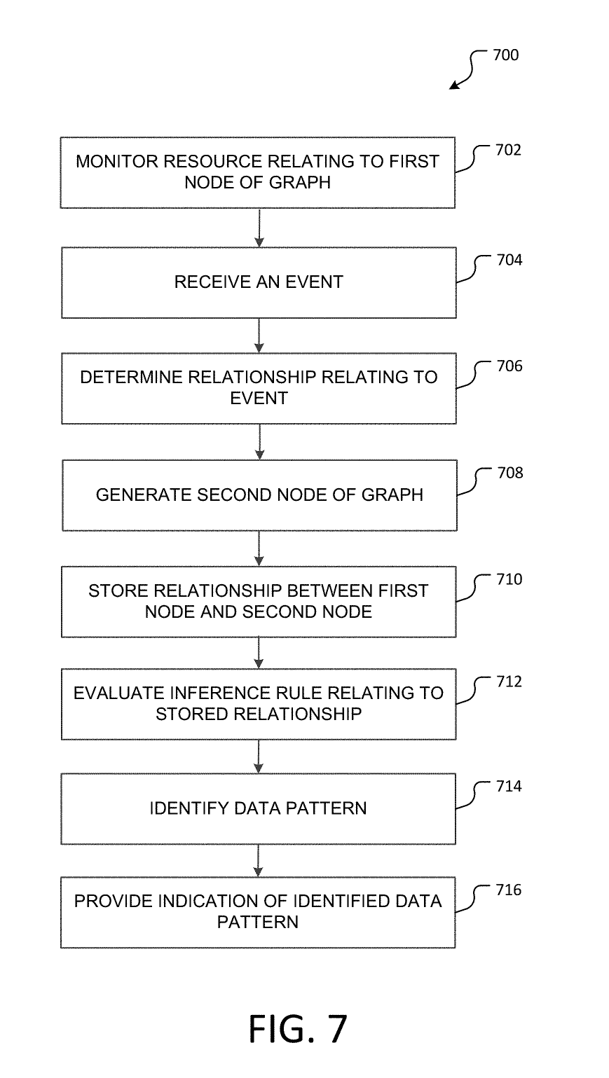

FIG. 7 depicts a method 700 for generating a collection of event data. Method 700 begins with monitor resource operation 702. As detailed above, event data may be tracked for various resources (e.g., websites, webpages, web elements, flash-driven elements, files, etc.). That is, resources may be monitored to detect user and/or system interactions (or triggers) with the resource. An interaction (or trigger) may be referred to herein as an event. For instance, a resource such as “button” type may be monitored for interactions (e.g., events) such as a “button click” type. Furthermore, a value of “click number” type may be associated with the “button click” event type. Alternatively, a resource of “video” type may be monitored for interactions (e.g., events) such as a “download” type, which may be associated with a value such as a “download time” type.

As should be appreciated, any number of resources may be monitored for any type of interaction. In some cases, event tracking is performed by an event tracking service, and in other cases, event tracking is performed by the system analyzing the event data. In further aspects, a library may dictate or define the event data that is received and/or collected. In some cases, a query may be received against event data. Based on the query, a graph may be generated including nodes representing resources (or events tracked for the resources) and edges between the nodes representing the determined relationships. In examples, a monitored resource may be associated with a first node of such a graph representing a collection of event data.

At receive operation 704, event data relating to monitored resources may be received. As detailed above, the event data may be provided by an event tracking service or performed by the system analyzing the event data. In aspects, a library may dictate or define the event data that is received and/or collected. In some examples, at least one event associated with a monitored resource associated with a first node of a graph may be received.

At determine relationship operation 706, one or more relationships within the event data are determined. For instance, identifiers associated with the event data may be extracted, including one or more of: resource type (e.g., web elements of “button” type, “scroll bar” type, “cursor” type; flash-driven elements of “video” type; files of “image file” type, “audio file” type, “document file” type, etc.), event type (e.g., for resource type “video,” event types may include a “download” type, a “play” type, a “pause” type, etc.), value type (e.g., for a “download” type, a value type may be “download time” or “download clicks” or “download rate,” etc.), and the like. Additionally, relationships that represent a correlation between two or more identifiers within the event data may be determined. For instance, a first identifier may be a “value type” (e.g., “download time” type) of a second identifier “event type” (e.g., “download” type). In such an example, the relationship between the value type and the event type may be “valueFor” or “valueOn,” or similar identifying text representing the relationship between the two identifiers. In some cases, one or more relationships between the at least one event associated with the monitored resource may be determined.

At generate node operation 708, a second node of a graph may be generated. As detailed above, the graph may include nodes representing resources (or events tracked for the resources) and edges between the nodes representing the determined relationships. In this case, the at least one event received for the monitored resource may be represented by the second node of the graph.

At store relationship operation 710, the determined relationship between the at least one event (represented by the second node) and the monitored resource (represented by the first node) may be stored in the graph. As detailed above, relationships between nodes may be referred to as “edges” within a graphical representation of the event data (also referred to herein as a collection of event data). In aspects, the collection of event data is generated as various nodes and edges are determined and stored in the graph. Moreover, as additional data is retrieved, analyzed and stored, the graph becomes more and more robust, allowing for better query results and improved event tracking analysis and responsiveness.

At evaluate inference rule operation 712, one or more inference rules may be applied to the graph (e.g., the collection of event data). In some cases, the one or more inference rules may be included in a ruleset that may be selected based in part on one or more stored relationships. As detailed above, a ruleset may be used to infer one or more relationships in a collection of event data. The ruleset may be stored in the Set itself, and in some examples stored as metadata within the Set. In some cases, the ruleset may be provided by a developer through a developer user interface. In other cases, the ruleset may be generated automatically based on the one or more stored relationships. Thus, different rulesets may be provided for different collections of event data. Further, rulesets may be fully customizable for each collection such that the developer may generate rules that are suitable for a particular application or use of the event data.

Further, at evaluate inference rule operation 712, the one or more inference rules may be evaluated with respect to the graph to generate inferred data. The inferred data may include inferred relationships and/or inferred type nodes. As detailed above, an inference rule of a ruleset may determine a type or class of an identifier based on a stored relationship that either has a domain or range of the particular identifier. For example, for a particular identifier, a “type” relationship may be created as well as a type node within the graph that indicates the type for the identifier.

At identify data pattern 714, based at least in part on the evaluation by the inference rule, a data pattern may be identified. In aspects, a data pattern may refer to an enriched collection of event data, as represented by an updated graph. As detailed above, an enriched collection of event data may include asserted identifiers and relationships as well as inferred identifiers and relationships. In this way, the enriched collection of event data may provide a more robust representation of the event data than the original collection. In some examples, the inferred data is permanently stored within the enriched collection. In other examples, the inferred data may be temporarily stored or cached for an amount of time sufficient for a query to be executed against the inferred data in the enriched collection.

At provide indication operation 716, an indication of the identified data pattern may be provided. In some cases, the indication of the identified data pattern may be automatically pushed to a developer, e.g., in a notification or otherwise. In other cases, the indication of the identified data pattern may be the result of a query against the enriched collection. In aspects, queries against such an enriched collection of event data may provide more robust results and reports, enabling developers to draw better conclusions regarding the tracked resources and to better interpret and respond to the collected event data. Moreover, in some aspects, based at least in part on the indication of the identified data pattern, a library defining specifications for tracking resources may be annotated. In this way, the resources and the events tracked may be refined in response to the identified data pattern. In some cases, the library may be annotated automatically, enabling real-time feedback between the analysis of prior event data and the refinement of future resources and events selected for tracking. In additional or alternative aspects, based at least in part on the indication of the identified data pattern, one or more inference rules used to evaluate collections of event data may be modified. As detailed above, such modifications may be made automatically in response to the indication of the identified data pattern.

As should be appreciated, operations 702-716 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

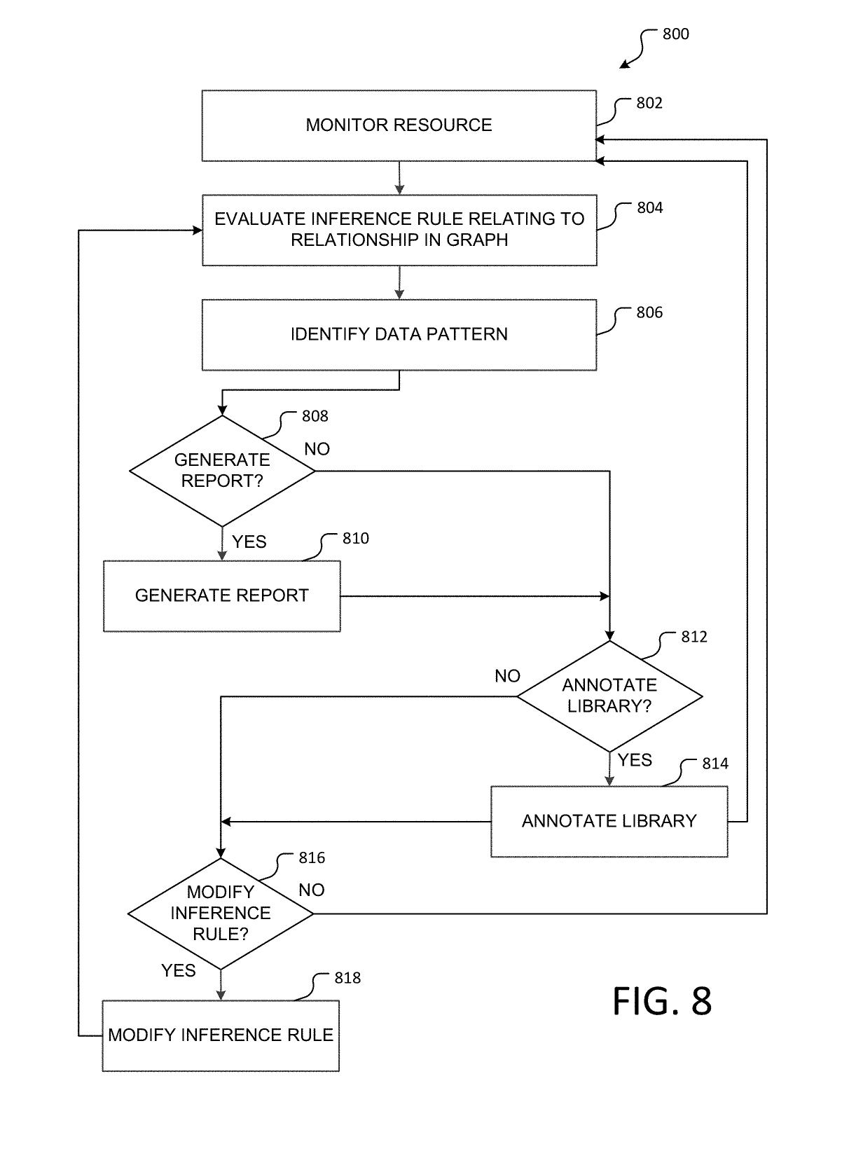

FIG. 8 depicts a method 800 for generating a self-tutoring graph of event data. Method 800 begins with monitor resource operation 802, which is similar to monitor resource operation 702. As detailed above, event data may be tracked for various resources (e.g., websites, webpages, web elements, flash-driven elements, files, applications, etc.). That is, resources may be monitored to detect user and/or system interactions (or triggers) with the resource. An interaction (or trigger) may be referred to herein as an event. For instance, a resource such as a “button” may be monitored for interactions (e.g., events) such as a “button click.” Furthermore, a value of “click number” may be associated with the “button click” event type. Alternatively, a resource of “video” may be monitored for interactions (e.g., events) such as a “download,” which may be associated with a value such as a “download time.” As should be appreciated, any number of resources may be monitored for any type of interaction. In some cases, event tracking is performed by an event tracking service, and in other cases, event tracking is performed by the system analyzing the event data.

At evaluate inference rule operation 804, similar to evaluate inference rule operation 712, one or more inference rules may be applied to a graph (e.g., a collection of event data). As detailed above, a ruleset may be used to infer one or more relationships in a collection of event data. The ruleset may be stored in the Set itself, and in some examples stored as metadata within the Set. In some cases, the ruleset may be provided by a developer through a developer user interface. In other cases, the ruleset may be generated automatically based on the one or more stored relationships. Further, at evaluate inference rule operation 804, the one or more inference rules may be evaluated with respect to the graph to generate inferred data. The inferred data may include inferred relationships and/or inferred type nodes. As detailed above, an inference rule of a ruleset may determine a type or class of an identifier based on a stored relationship that either has a domain or range of the particular identifier. For example, for a particular identifier, a “type” relationship may be created as well as a type node within the graph that indicates the type for the identifier.

At identify data pattern operation 806, similar to identify data pattern operation 714, a data pattern may be identified based at least in part on the evaluation by the inference rule. In aspects, a data pattern may refer to an enriched collection of event data, as represented by an an updated graph. As detailed above, an enriched collection of event data may include asserted identifiers and relationships as well as inferred identifiers and relationships. In this way, the enriched collection of event data may provide a more robust representation of the event data than the original collection. In some examples, the inferred data is permanently stored within the enriched collection. In other examples, the inferred data may be temporarily stored or cached for an amount of time sufficient for a query to be executed against the inferred data in the enriched collection.

At determination operation 808, it may be determined whether to generate a report. In some cases, a report may be generated automatically upon generating the enriched collection of data based on the one or more inference rules. In other cases, a report may be generated when changes to the collection of event data meet a threshold. That is, in cases where applying the one or more inference rules to the collection of data resulted in minimal to no changes within the collection of event data, a report may not be generated. In still other cases, a report may be generated only in response to a user selection and it may be determined whether such a selection was received. If it is determined to generate a report, the method may proceed to generate report operation 810. If it is determined not to generate a report, the method may proceed to determination operation 812.

At generate report operation 810, a report may be generated. For instance, based at least in part on the identified data pattern, a report (e.g., an event log or other report) may automatically be generated and forwarded to a developer. In other cases, the report may include the results of a query against the enriched collection. As detailed above, queries against such an enriched collection of event data may provide more robust results and reports, enabling developers to draw better conclusions regarding the tracked resources and to better interpret and respond to the collected event data. That is, based on the collected event data, as well as asserted and inferred relationships within a graphical representation of the collected event data, a more robust and detailed report may be generated. After generating the report, whether automatically or by user selection or query, the method may continue to determination operation 812.

At determination operation 812, it may be determined whether a library should be annotated. As described above, the library may define or dictate resources and/or events relating to the resources for tracking. In some cases, an event tracking service may collect event data based on the library. In this respect, annotations to the library may alter the event data returned by the service. If it is determined to annotate a library, the method may continue to the annotate library operation 814. If it is determined not to annotate the library, the method may continue to determination operation 816.

At annotate library operation 814, a library defining resources and/or events for tracking may be annotated. Annotations to the library may adapt method calls within the library so as to track additional and/or different resources and/or additional or different events related to the resources. In some cases, annotations to the library may be generated automatically in response to identifying a data pattern within the event data (e.g., an enriched collection of event data). In other cases, annotations to the library may be made manually by a developer based on analysis of the identified data pattern. In this way, annotating the library may result in tracked event data becoming more and more useful for providing information about interactions with web elements. In aspects, automatic annotation of the library may provide real-time feedback for refining event tracking. After annotating the library, whether automatically or manually, the method may return to monitor resource operation 802 based on the annotated library, and/or may continue to determination operation 816.

At determination operation 816, it may be determined whether one or more inference rules should be modified. As detailed above, inference rules may be applied to a collection of event data to infer one or more relationships within the collection. In some cases, the one or more inference rules may be fully customizable for each collection such that a developer may generate rules that are suitable for a particular application or use of the event data. For example, based at least in part on an identified data pattern associated with event data, a developer may determine that one or more inference rules should be modified to determine one or more different inferred relationships and/or identifiers within the data. Alternatively, based at least in part on an identified data pattern, one or more inference rules may be automatically modified. If it is determined to modify an inference rule, the method may continue to the modify inference rule operation 818. If it is determined not to modify an inference rule, the method may return to monitor resource operation 802.

At modify inference rule operation 818, at least one inference rule may be modified. In aspects, modifications to inference rules may be made continually in real time so as to produce a self-tutoring graph of event data. In this way, developers may create and analyze collections of event data in near real time, as well as refine such collections of event data by making modifications to the analysis and reporting of event data in near real time. In this way, the event data may become more and more useful for evaluating interactions with web elements. In aspects, a self-tutoring graph of event data may continually evolve in response to changing conditions and/or adaptive analyses. In this regard, the systems and methods herein provide developers with the tools to decrease response time and increase educated decision making with respect to a tracked system. In aspects, upon modifying an inference rule, the method may return to monitor resource operation 802.

As should be appreciated, operations 802-818 are described for purposes of illustrating the present methods and systems and are not intended to limit the disclosure to a particular sequence of steps, e.g., steps may be performed in differing order, additional steps may be performed, and disclosed steps may be excluded without departing from the present disclosure.

FIGS. 9-12 and the associated descriptions provide a discussion of a variety of operating environments in which aspects of the technology may be practiced. However, the devices and systems illustrated and discussed with respect to FIGS. 9-12 are for purposes of example and illustration and are not limiting of a vast number of computing device configurations that may be utilized for practicing aspects of the disclosure, described herein.

FIG. 9 is a block diagram illustrating physical components (e.g., hardware) of a computing device 900 with which aspects of the disclosure may be practiced. The computing device components described below may be suitable for the computing devices described above, including the client computing devices 102A-C and the server computing devices 106A-C. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories. The system memory 904 may include an operating system 905 and one or more program modules 906 suitable for running software application 920, such as one or more components supported by the systems described herein. As examples, system memory 904 may store isolated collection data (e.g., resource identifiers, resource metadata, relationship information, asserted/inferred relationships, graphical mapping information, query data, rule sets, such as, for example, inference rules, authorization information, authentication information, etc.) and instructions for managing versions of rulesets and enriching isolated collections. The operating system 905, for example, may be suitable for controlling the operation of the computing device 900. Furthermore, embodiments of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the processing unit 902, the program modules 906 (e.g., applications 920, such as collection creation application 921) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The computing device 900 may include one or more communication connections 916 allowing communications with other computing devices 950. Examples of suitable communication connections 916 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

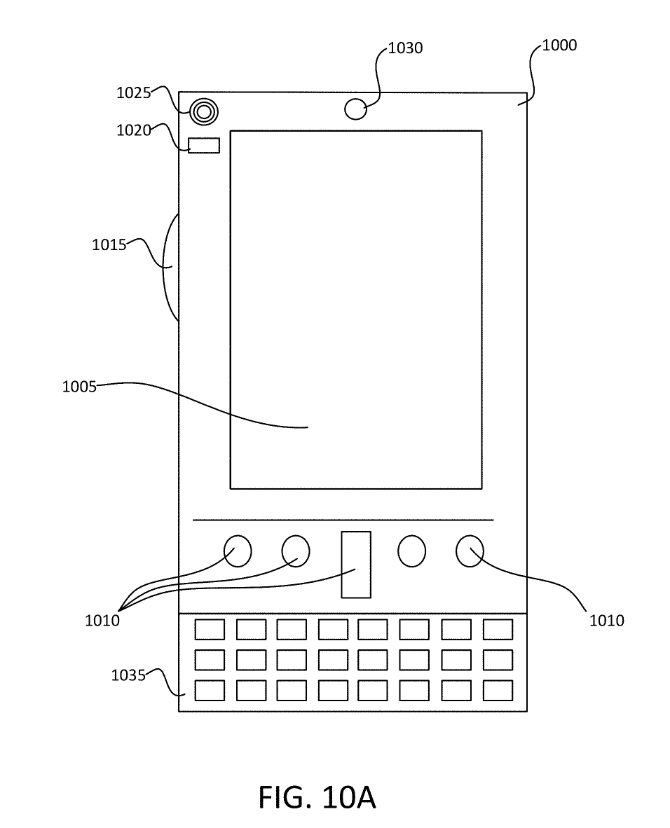

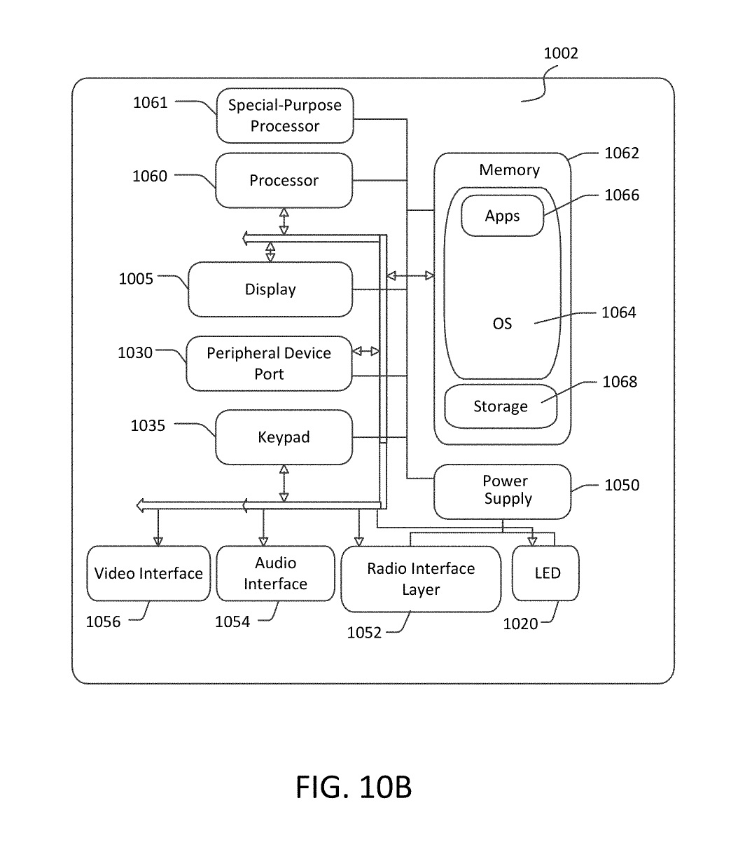

FIGS. 10A and 10B illustrate a mobile computing device 1000, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 10A, one aspect of a mobile computing device 1000 for implementing the aspects is illustrated. In a basic configuration, the mobile computing device 1000 is a handheld computer having both input elements and output elements. The mobile computing device 1000 typically includes a display 1005 and one or more input buttons 1010 that allow the user to enter information into the mobile computing device 1000. The display 1005 of the mobile computing device 1000 may also function as an input device (e.g., a touch screen display). If included, an optional side input element 1015 allows further user input. The side input element 1015 may be a rotary switch, a button, or any other type of manual input element. In alternative aspects, mobile computing device 1000 may incorporate more or less input elements. For example, the display 1005 may not be a touch screen in some embodiments. In yet another alternative embodiment, the mobile computing device 1000 is a portable phone system, such as a cellular phone. The mobile computing device 1000 may also include an optional keypad 1035. Optional keypad 1035 may be a physical keypad or a “soft” keypad generated on the touch screen display. In various embodiments, the output elements include the display 1005 for showing a graphical user interface (GUI), a visual indicator 1020 (e.g., a light emitting diode), and/or an audio transducer 1025 (e.g., a speaker). In some aspects, the mobile computing device 1000 incorporates a vibration transducer for providing the user with tactile feedback. In yet another aspect, the mobile computing device 1000 incorporates input and/or output ports, such as an audio input (e.g., a microphone jack), an audio output (e.g., a headphone jack), and a video output (e.g., a HDMI port) for sending signals to or receiving signals from an external device.

FIG. 10B is a block diagram illustrating the architecture of one aspect of a mobile computing device. That is, the mobile computing device 1000 can incorporate a system (e.g., an architecture) 1002 to implement some aspects. In one embodiment, the system 1002 is implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000 described herein (e.g., search engine, extractor module, relevancy ranking module, answer scoring module, etc.).

The system 1002 has a power supply 1050, which may be implemented as one or more batteries. The power supply 1050 might further include an external power source, such as an AC adapter or a powered docking cradle that supplements or recharges the batteries.

The system 1002 may also include a radio interface layer 1052 that performs the function of transmitting and receiving radio frequency communications. The radio interface layer 1052 facilitates wireless connectivity between the system 1002 and the “outside world,” via a communications carrier or service provider. Transmissions to and from the radio interface layer 1052 are conducted under control of the operating system 1064. In other words, communications received by the radio interface layer 1052 may be disseminated to the application programs 1066 via the operating system 1064, and vice versa.

The visual indicator 1020 may be used to provide visual notifications, and/or an audio interface 1054 may be used for producing audible notifications via the audio transducer 1025. In the illustrated embodiment, the visual indicator 1020 is a light emitting diode (LED) and the audio transducer 1025 is a speaker. These devices may be directly coupled to the power supply 1050 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1054 is used to provide audible signals to and receive audible signals from the user. For example, in addition to being coupled to the audio transducer 1025, the audio interface 1054 may also be coupled to a microphone to receive audible input, such as to facilitate a telephone conversation. In accordance with embodiments of the present disclosure, the microphone may also serve as an audio sensor to facilitate control of notifications, as will be described below. The system 1002 may further include a video interface 1056 that enables an operation of an on-board camera 1030 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10B by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio interface layer 1052 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio interface layer 1052 or via a distributed computing network. Similarly, such data/information may be readily transferred between computing devices for storage and use according to well-known data/information transfer and storage means, including electronic mail and collaborative data/information sharing systems.

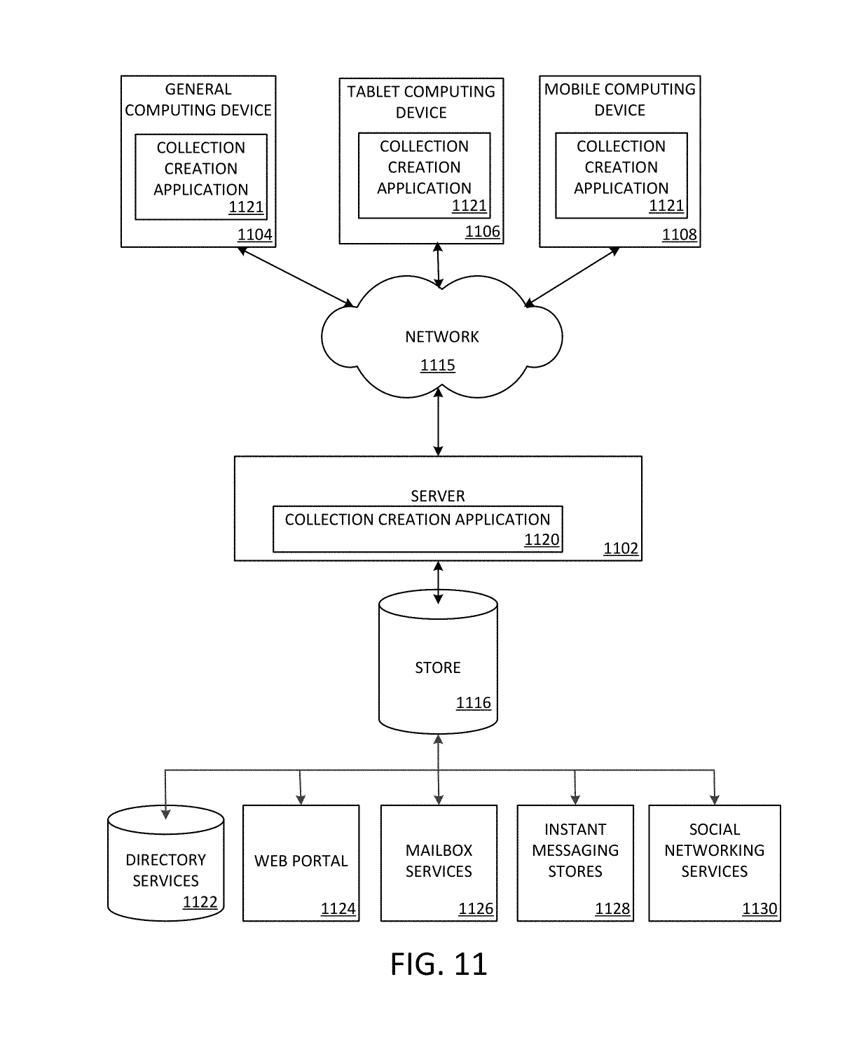

FIG. 11 illustrates one aspect of the architecture of a system for processing data received at a computing system from a remote source, such as a personal computer 1104, tablet computing device 1106, or mobile computing device 1108, as described above. Content displayed at server device 1102 may be stored in different communication channels or other storage types. For example, various documents may be stored using a directory service 1122, a web portal 1124, a mailbox service 1126, an instant messaging store 1128, or a social networking site 1130. A collection creation application 1121 may be employed by a client that communicates with server device 1102, and/or the collection creation application 1120 may be employed by server device 1102. The server device 1102 may provide data to and from a client computing device such as a personal computer 1104, a tablet computing device 1106 and/or a mobile computing device 1108 (e.g., a smart phone) through a network 1115. By way of example, the computer system described above may be embodied in a personal computer 1104, a tablet computing device 1106 and/or a mobile computing device 1108 (e.g., a smart phone). Any of these embodiments of the computing devices may obtain content from the store 1116, in addition to receiving graphical data useable to be either pre-processed at a graphic-originating system, or post-processed at a receiving computing system.

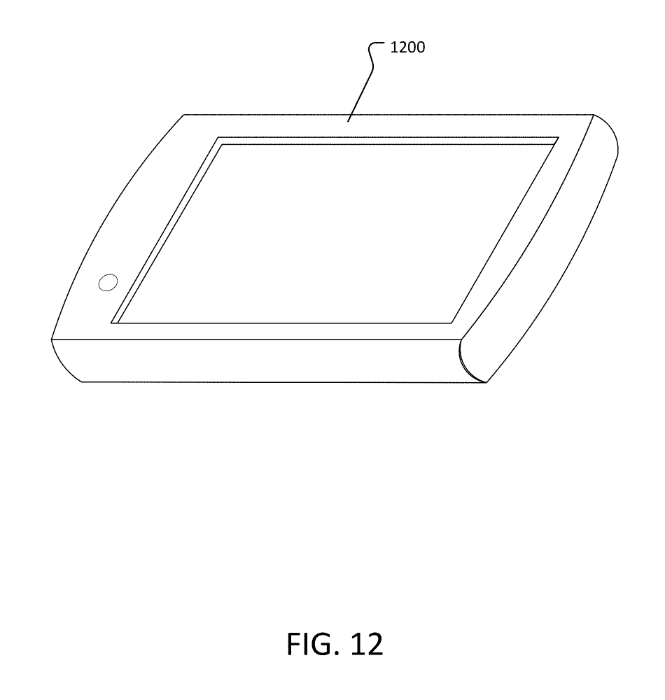

FIG. 12 illustrates an exemplary tablet computing device 1200 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and a memory storing instructions that when executed by the at least one processor perform a set of operations. The operations comprise accessing a first isolated collection comprising at least two asserted resource identifiers and at least one asserted relationship; receiving a first ruleset for the first isolated collection, wherein one or more rules in the first ruleset are based on values of the asserted relationships; accessing a second isolated collection of asserted resources and relationships; receiving a second ruleset for the second isolated collection, wherein one or more rules in the first ruleset are based on values of the asserted relationships; executing the first ruleset against the first isolated collection to generate one or more inferred relationships between the asserted resources in the first isolated collection; storing the one or more inferred relationships in the first isolated collection; executing the second ruleset against the second isolated collection to generate one or more additional inferred relationships between the asserted resources in the second isolated collection; and storing the one or more additional inferred relationships in the second isolated collection. In an example, the operations further comprise displaying a graph showing each of the asserted resources as nodes within the graph and each of the asserted relationships and the first plurality of inferred relationships as edges between the nodes. In another example, the operations further comprise displaying the asserted relationships in a first format and the first plurality of inferred relationships in a second format. In yet another example, the operations further comprise sending a notification upon completion of the processing of the first ruleset.

In another aspect, the technology relates to a computer-implemented method for enriching asserted data. The method comprises accessing a first isolated collection comprising at least two resource indicators and at least one asserted relationship; receiving a first ruleset for the first isolated collection, wherein one or more rules in the first ruleset are based on values of the asserted relationships; accessing a second isolated collection of asserted resources and relationships; receiving a second ruleset for the second isolated collection, wherein one or more rules in the first ruleset are based on values of the asserted relationships; processing the first ruleset against the first isolated collection to generate at least one inferred relationship in the first isolated collection; storing the at least one inferred relationships in the first isolated collection; processing the second ruleset against the second isolated collection to generate a second plurality of additional inferred relationships between two or more of the asserted resource indicators in the second isolated collection; and storing the second plurality of additional inferred relationships in the second isolated collection. In an example, each resource indicator represents a resource, and the resource is one of a file, a website, a document, a contact, a task, an e-mail, a communication channel, or a calendar event. In another example, each resource indicator includes a durable Uniform Resource Identifier (URI) or internationalized resource identifier (IRI) pointing to a particular resource for which the resource indicator represents. In yet another example, the processing of the second ruleset occurs upon the receiving of the second isolated collection. In still yet another example, the first plurality of inferred relationships is maintained separately from the asserted relationships in the first isolated collection. In a further example, the method further comprises preventing deletion of the asserted relationships in the first isolated collection when processing the first ruleset.

In another example, the method further comprises displaying a graph showing each of the asserted resources as nodes within the graph and each of the asserted relationships and the inferred relationships as edges between the nodes. In yet another example, the method further comprises displaying the asserted relationships in a first format and the inferred relationships in a second format. In still yet another example, the method further comprises receiving a query for data in the first isolated collection; executing the query against the first isolated collection; and returning results to the query based on the asserted resources, the asserted relationships, and the inferred relationships in the first isolated collection. In still yet another example, the method further comprises processing a third ruleset against both the first isolated collection and a third isolated collection, wherein the third ruleset has an associated hierarchy level higher than the first ruleset and the second ruleset.

In another aspect, the technology relates to another computer-implemented method for enriching asserted data. The method comprises accessing an isolated collection of asserted resources and asserted relationships between the asserted resources; receiving, through a developer user interface, a first ruleset for the isolated collection, wherein one or more rules in the first ruleset are based on values of the asserted relationships; determining a first subset of rules in the first ruleset requiring a processing time above a threshold; determining a second subset of rules in the first ruleset requiring a processing time below the threshold; receiving an additional asserted relationship to the isolated collection; upon receiving the additional asserted relationship, executing the first subset of rules to generate a first plurality of inferred relationships between the asserted resources in the isolated collection; and receiving a query against the isolated collection; upon receiving the query, executing the second subset of rules to generate a second plurality of inferred relationships between the resources in the first isolated collection; and returning results to the query, wherein the results include at least a portion of the first plurality of inferred relationships and a portion of the second plurality of inferred relationships. In an example, the method further comprises obtaining a second isolated collection of asserted resources and asserted relationships between the asserted resources; receiving a second ruleset, the second ruleset having a hierarchy level higher than a hierarchy level of the first ruleset; and based on the hierarchy level of second ruleset, processing the second ruleset against both the first isolated collection and the second isolated collection to generate additional inferred relationships in the first isolated collection and the second isolated collection. In another example, each resource indicator is a durable Uniform Resource Identifier (URI) or internationalized resource identifier (IRI) pointing to a particular resource for which the resource indicator represents. In yet another example, each resource indicator represents a resource, and the resource is one of a file, a website, a document, a contact, a task, an e-mail, a communication channel, or a calendar event. In still yet another example, the method further comprises displaying the results as a graph showing each of the asserted resources as nodes within the graph and each of the asserted relationships and the first plurality of inferred relationships as edges between the nodes. In a further example, the method further comprises displaying the asserted relationships in a first format and the first plurality of inferred relationships in a second format.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Further, while multiple examples and embodiments have been discussed herein, it should be understood that features from one example may be combined with features from any other example. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
a memory storing instructions that when executed by the at least one processor perform a set of operations comprising:
receiving event data based at least in part on a library;
generating a first collection of event data, wherein the first collection comprises at least two first identifiers and at least one first asserted relationship;
receiving a first ruleset for the first collection, wherein one or more rules in the first ruleset are based at least in part on the at least one first asserted relationship;
executing the first ruleset against the first collection to generate one or more first inferred relationships between the at least two first identifiers in the first collection;
storing the one or more first inferred relationships in the first collection as an enriched first collection; and
based at least in part on the one or more first inferred relationships, annotating the library.

2. The system of claim 1, further comprising:
receiving event data based at least in part on the annotated library; and
generating a second collection of event data, wherein the second collection comprises at least two second identifiers and at least one second asserted relationship, and wherein the at least one second asserted relationship is different from the at least one first asserted relationship.

3. The system of claim 1, further comprising:
receiving event data based at least in part on the annotated library; and
generating a second collection of event data, wherein the second collection comprises at least two second identifiers and at least one second asserted relationship, and wherein at least one second identifier is different from at least one first identifier.

4. The system of claim 1, further comprising:
automatically annotating the library.

5. The system of claim 1, further comprising:
annotating the library based on an indication to annotate the library.

6. The system of claim 2, further comprising:
receiving a second ruleset for the second collection, wherein one or more rules in the second ruleset are based at least in part on the at least one second asserted relationship; and
executing the second ruleset against the second collection to generate one or more second inferred relationships between the at least two second identifiers in the second collection, wherein at least one second inferred relationship is different from at least one first inferred relationship.

7. The system of claim 6, further comprising:
based at least in part on the one or more second inferred relationships, annotating the annotated library.

8. The system of claim 2, further comprising:
receiving a first query to the enriched first collection; and
generating a first event log.

9. The system of claim 8, further comprising:
receiving a second query to the second collection; and
generating a second event log.

10. The system of claim 9, wherein the first event log is different than the second event log.

11. The system of claim 6, wherein one or more rules in the second ruleset are based at least in part on the one or more first inferred relationships generated for the first collection.

12. A computer-implemented method for analyzing event data, the method comprising:
monitoring a resource relating to a first node in a graph;
based on the monitoring, receiving an event;
determining, based on the event, a relationship relating to the event;
generating a second node in the graph;
storing the relationship as a stored relationship between the first node and the second node;
evaluating an inference rule relating to the stored relationship to identify a data pattern; and
providing an indication relating to the identified data pattern.

13. The computer-implemented method of claim 12, further comprising:
in response to the indication, annotating a library.

14. The computer-implemented method of claim 13, wherein monitoring the resource is determined by the annotated library.

15. The computer-implemented method of claim 12, wherein the event is a representation of a trigger.

16. The computer-implemented method of claim 12, wherein the trigger represents an interaction between a system and another system or a user.

17. The computer-implemented method of claim 12, further comprising:
modifying the inference rule based at least in part on the indication.

18. A computer storage medium comprising computer-executable instructions that when executed by a processor perform a method of analyzing event data, the method comprising:
monitoring a resource relating to a first node in a graph;
based on the monitoring, receiving an event;
determining, based on the event, a relationship relating to the event;
generating a second node in the graph;
storing the relationship as a stored relationship between the first node and the second node;
evaluating an inference rule relating to the stored relationship to identify a data pattern; and
based at least in part on the identified data pattern, modifying the inference rule.

19. The computer storage medium of claim 18, further comprising:
evaluating the modified inference rule relating to the stored relationship to identify a different data pattern.

20. The computer storage medium of claim 18, further comprising:
based at least in part on the identified data pattern, annotating a library; and
monitoring the resource based at least in part on the annotated library.
